(19) United States
(12) Patent Application Publication
(10) Pub. No.: US 2021/0266561 A1
(43) Pub. Date: Aug. 26, 2021

(54) MOTION INFORMATION ENCODING APPARATUS AND ENCODING METHOD, AND MOTION INFORMATION DECODING APPARATUS AND DECODING METHOD

(71) Applicant: SAMSUNG ELECTRONICS CO., LTD, Suwon-si (KR)

(72) Inventors: Seung-soo JEONG, Seoul (KR); Chan-yul KIM, Seongnam-si (KR); Min-soo PARK, Seoul (KR); Min-woo PARK, Yongin-si (KR); Ki-ho CHOI, Seoul (KR); Na-rae CHOI, Seoul (KR); Woong-il CHOI, Osan-si (KR); Anish TAMSE, Seoul (KR); Yin-ji PIAO, Yongin-si (KR)

(73) Assignee: SAMSUNG ELECTRONICS CO., LTD., Suwon-si (KR)

(21) Appl. No.: 17/255,599

(22) PCT Filed: Jun. 26, 2018
(86) PCT No.: PCT/KR2018/007213

§ 371 Date: Dec. 23, 2020

(51) Int. Cl. H04N 19/139; H04N 19/176; H04N 19/513; H04N 19/115

(52) U.S. Cl. CPC H04N 19/139; H04N 19/115; H04N 19/521; H04N 19/176

(57) ABSTRACT

A method of decoding motion information includes determining a coding factor value of a differential motion vector of a current block, when adaptive encoding has been applied to the differential motion vector, determining a first result value generated by applying the adaptive encoding to the differential motion vector, based on information included in the bitstream, obtaining the differential motion vector by applying the determined coding factor value to the first result value according to a certain operation, and obtaining a motion vector of the current block, based on the obtained differential motion vector and a prediction motion vector of the current block.

### TECHNICAL FIELD

The present disclosure relates to the field of image encoding and image decoding. In particular, the present disclosure relates to a method and apparatus for encoding motion information of an image and a method and apparatus for decoding motion information of an image.

### BACKGROUND ART

In encoding and decoding of an image, one picture may be split into blocks in order to encode an image, and each of the blocks may be prediction-encoded via inter prediction or intra prediction.

Inter prediction refers to a method of compressing an image by removing temporal redundancy between pictures, a representative example of which is motion estimation encoding. In the motion estimation encoding, blocks of a current picture are predicted by using at least one reference picture. A reference block most similar to a current block may be searched for in a certain search range by using a certain evaluation function. The current block is predicted based on the reference block, and a residual block is generated by subtracting a prediction block, generated as a result of the prediction, from the current block and then encoded. Here, to further accurately perform the prediction, interpolation is performed on a search range of reference pictures so as to generate pixels of sub pel units smaller than integer pel units, and inter prediction may be performed based on the generated pixels of sub pel units.

In a codec such as H.264advanced video coding (AVC) and high efficiency video coding (HEVC), a motion vector of pre-encoded blocks adjacent to a current block or blocks included in a pre-encoded picture is used as a prediction motion vector of the current block so as to predict a motion vector of the current block. A differential motion vector that is a difference between the motion vector of the current block and the prediction motion vector is signaled to a decoder by using a certain method.

### DESCRIPTION OF EMBODIMENTS

### Technical Problem

Technical problems of an apparatus and method of encoding motion information, and an apparatus and method of decoding motion information, according to an embodiment, involve encoding the differential motion vector of a current block at a low bitrate.

### TECHNICAL SOLUTION TO PROBLEM

A method of decoding motion information, according to an embodiment, includes determining a coding factor value of a differential motion vector of a current block, when adaptive encoding has been applied to the differential motion vector, determining a first result value generated by applying the adaptive encoding to the differential motion vector, based on information included in the bitstream, obtaining the differential motion vector by applying the determined coding factor value to the first result value according to a certain operation, and obtaining a motion vector of the current block, based on the obtained differential motion vector and a prediction motion vector of the current block.

### Advantageous Effects of Disclosure

In an apparatus and method of encoding motion information, and an apparatus and method of decoding motion information, according to an embodiment, the differential motion vector of a current block may be encoded at a low bitrate.

However, effects achievable by an apparatus and method of encoding motion information and an apparatus and method of decoding motion information are not limited to those mentioned above, and other effects that not mentioned could be clearly understood by one of ordinary skill in the art from the following description.

### BRIEF DESCRIPTION OF DRAWINGS

A brief description of each drawing is provided to better understand the drawings cited herein.

FIG. 1 is a block diagram of an image decoding apparatus capable of decoding an image, based on at least one of block shape information and split shape information, according to an embodiment.

FIG. 2 is a block diagram of an image encoding apparatus capable of encoding an image, based on at least one of block shape information and split shape information, according to an embodiment.

FIG. 3 illustrates a process of determining at least one coding unit by splitting a current coding unit, according to an embodiment.

FIG. 4 illustrates a process of determining at least one coding unit by splitting a non-square coding unit, according to an embodiment.

FIG. 5 illustrates a process of splitting a coding unit based on at least one of block shape information and split shape information, according to an embodiment.

FIG. 6 illustrates a method of determining a certain coding unit from among an odd number of coding units, according to an embodiment.

FIG. 7 illustrates an order of processing a plurality of coding units when a current coding unit is split and the plurality of coding units are determined, according to an embodiment.

FIG. 8 illustrates a process of determining that a current coding unit is to be split into an odd number of coding units, when the coding units are not processable in a certain order, according to an embodiment.

FIG. 9 illustrates a process of determining at least one coding unit by splitting a first coding unit, according to an embodiment.

FIG. 10 illustrates that, when a second coding unit having a non-square shape, which is determined by splitting a first coding unit, satisfies a certain condition, a shape into which the second coding unit is splittable is restricted, according to an embodiment.

FIG. 11 illustrates a process of splitting a square coding unit when split shape information is unable to indicate that the square coding unit is split into four square coding units, according to an embodiment.

FIG. 12 illustrates that a processing order between a plurality of coding units may be changed depending on a process of splitting a coding unit, according to an embodiment.

FIG. 13 illustrates a process of determining a depth of a coding unit as a shape and size of the coding unit change, when the coding unit is recursively split such that a plurality of coding units are determined, according to an embodiment.

FIG. 14 illustrates depths that are determinable based on shapes and sizes of coding units, and part indexes (PIDs) that are for distinguishing the coding units, according to an embodiment.

FIG. 15 illustrates that a plurality of coding units are determined based on a plurality of certain data units included in a picture, according to an embodiment.

FIG. 16 illustrates a processing block serving as a criterion for determining a determination order of reference coding units included in a picture, according to an embodiment.

FIG. 17 illustrates coding units that may be determined for each picture when a combination of shapes into which a coding unit is splittable is different for each picture, according to an embodiment.

FIG. 18 illustrates various shapes of a coding unit that may be determined based on split shape information representable in a binary code, according to an embodiment.

FIG. 19 illustrates other shapes of a coding unit that may be determined based on split shape information representable in a binary code, according to an embodiment.

FIG. 20 is a block diagram of an image encoding and decoding system that performs loop filtering.

FIG. 21 is a block diagram of an image decoding apparatus according to an embodiment.

FIG. 22 is a table showing factor values corresponding to factor value indicating indexes.

FIG. 23 is a diagram illustrating a motion vector, a prediction motion vector, and a differential motion vector related to a current block that is predicted bidirectionally.

FIG. 24 is a diagram illustrating a temporal and/or spatial neighboring block temporally and/or spatially related to a current block.

FIG. 25 is a table showing motion vector resolutions (MVRs) corresponding to indexes.

FIG. 26 illustrates a syntax that obtains information about an MVR from a bitstream.

FIG. 27 is a flowchart of a method of decoding motion information, according to an embodiment.

FIG. 28 is a block diagram of an image encoding apparatus according to an embodiment.

FIG. 29 is a flowchart of a method of encoding motion information, according to an embodiment.

FIG. 30 illustrates positions of pixels that may be indicated by motion vectors according to a ¼ pixel unit MVR, a ½ pixel unit MVR, a 1 pixel unit MVR, and a 2 pixel unit MVR.

FIGS. 31 and 32 are views for explaining a prediction motion vector adjusting method according to an embodiment.

### BEST MODE

A method of decoding motion information, according to an embodiment, includes determining a coding factor value of a differential motion vector of a current block, when adaptive encoding has been applied to the differential motion vector, determining a first result value generated by applying the adaptive encoding to the differential motion vector, based on information included in the bitstream, obtaining the differential motion vector by applying the determined coding factor value to the first result value according to a certain operation, and obtaining a motion vector of the current block, based on the obtained differential motion vector and a prediction motion vector of the current block.

The determining of the first result value may include determining a second result value generated by applying the adaptive encoding to the differential motion vector, based on information included in the bitstream, and the determining of the differential motion vector may include obtaining the differential motion vector by further applying the second result value to the certain operation.

The determining of the coding factor value of the differential motion vector may include obtaining factor value indicating information from the bitstream, and determining the coding factor value, based on the obtained factor value indicating information.

The determining of the coding factor value of the differential motion vector may include determining the coding factor value of the differential motion vector, based on information related to at least one of the current block, a pre-decoded block, a current slice including the current block, a pre-decoded slice, a current picture including the current block, and a pre-decoded picture.

The method may further include, when adaptive encoding is not applied to the differential motion vector of the current block, determining the differential motion vector of the current block, based on information obtained from the bitstream.

The method may further include determining a first motion vector resolution of a first component of the motion vector of the current block and a second motion vector resolution of a second component of the motion vector of the current block, adjusting a first component value and a second component value of the prediction motion vector, based on results of comparisons between a predetermined minimum motion vector resolution and each of the first motion vector resolution and the second motion vector resolution, and obtaining the motion vector of the current block, based on the adjusted prediction motion vector and the differential motion vector.

The determining of the coding factor value of the differential motion vector may include determining the coding factor value, based on the first motion vector resolution and the second motion vector resolution.

The adjusting of the first component value and the second component value of the prediction motion vector may include adjusting the first component value of the prediction motion vector when the first motion vector resolution is greater than the minimum motion vector resolution, and adjusting the second component value of the prediction motion vector when the second motion vector resolution is greater than the minimum motion vector resolution.

The determining of the first motion vector resolution and the second motion vector resolution may include determining the first motion vector resolution and the second motion vector resolution, based on information representing the first motion vector resolution, which is obtained from the bitstream, and information representing the second motion vector resolution, which is obtained from the bitstream.

The determining of the first motion vector resolution and the second motion vector resolution may include determining the first motion vector resolution and the second motion vector resolution, based on a width and a height of the current block.

The determining of the first motion vector resolution and the second motion vector resolution may include determining the first motion vector resolution and the second motion vector resolution so that the first motion vector resolution is greater than the second motion vector resolution, when the width is larger than the height.

An image decoding apparatus includes an obtainer configured to obtain a bitstream; and a prediction decoder configured to determine a coding factor value of a differential motion vector of a current block, when adaptive encoding has been applied to the differential motion vector, determine a first result value generated by applying the adaptive encoding to the differential motion vector, based on information included in the bitstream, obtain the differential motion vector by applying the determined coding factor value to the first result value according to a certain operation, and obtain a motion vector of the current block, based on the obtained differential motion vector and a prediction motion vector of the current block.

A method of encoding motion information includes obtaining a differential motion vector of a current block, based on a motion vector of the current block and a prediction motion vector of the current block, determining a coding factor value of the differential motion vector, when adaptive encoding is applied to the differential motion vector, obtaining a first result value of the differential motion vector by applying the determined coding factor value to the differential motion vector according to a certain operation, and generating a bitstream, based on the first result value of the differential motion vector.

The method may further include obtaining a second result value of the differential motion vector by applying the determined coding factor value to the differential motion vector according to the certain operation, and the generating of the bitstream may include generating the bitstream, based on the first result value and the second result value of the differential motion vector.

The determining of the coding factor value of the differential motion vector may include, when each of a plurality of factor value candidates is applied to the differential motion vector, determining a factor value candidate causing a smallest overall number of bits of a first result value and a second result value of the differential motion vector and factor value indication information representing a factor value candidate, to be the coding factor value of the differential motion vector of the current block.

### MODE OF DISCLOSURE

As the disclosure allows for various changes and numerous examples, particular embodiments will be illustrated in the drawings and described in detail in the written description. However, this is not intended to limit the disclosure to particular modes of practice, and it will be understood that all changes, equivalents, and substitutes that do not depart from the spirit and technical scope of the disclosure are encompassed in the disclosure.

In the description of embodiments, certain detailed explanations of related art are omitted when it is deemed that they may unnecessarily obscure the essence of the disclosure. Also, numbers (for example, a first, a second, and the like) used in the description of the specification are merely identifier codes for distinguishing one element from another.

Also, in the present specification, it will be understood that when elements are “connected” or “coupled” to each other, the elements may be directly connected or coupled to each other, but may alternatively be connected or coupled to each other with an intervening element therebetween, unless specified otherwise.

In the present specification, regarding an element represented as a “unit” or a “module”, two or more elements may be combined into one element or one element may be divided into two or more elements according to subdivided functions. In addition, each element described hereinafter may additionally perform some or all of functions performed by another element, in addition to main functions of itself, and some of the main functions of each element may be performed entirely by another component.

Also, in the present specification, an ‘image’ or a ‘picture’ may denote a still image of a video or a moving image, i.e., the video itself.

Also, in the present specification, a ‘sample’ denotes data assigned to a sampling position of an image, i.e., data to be processed. For example, pixel values of an image in a spatial domain and transform coefficients on a transform region may be samples. A unit including at least one such sample may be defined as a block.

Also, in the present specification, a ‘current block’ may denote a block of a largest coding unit, coding unit, prediction unit, or transform unit of a current image to be encoded or decoded.

In addition, in the present specification, ‘motion vector resolution (MVR)’ refers to precision of a position of a pixel that may be indicated by a motion vector determined through inter prediction among the pixels included in a reference image (or an interpolated reference image). When a motion vector resolution has an N pixel unit (where N is a rational number), it means that a motion vector may have precision of an N pixel unit. For example, an MVR of a ¼ pixel unit may mean that a motion vector may indicate a pixel position of a ¼ pixel unit (i.e., a subpixel unit) in an interpolated reference image, and MVR of a 1 pixel unit may mean that a motion vector may indicate a pixel position corresponding to a 1 pixel unit (i.e., an integer pixel unit) in an interpolated reference image.

In addition, in the present specification, a ‘candidate of motion vector resolution’ means one or more motion vector resolutions that may be selected as the motion vector resolution of a block.

Moreover, in this specification, the term ‘pixel unit’ may be replaced with terms such as pixel precision and pixel accuracy.

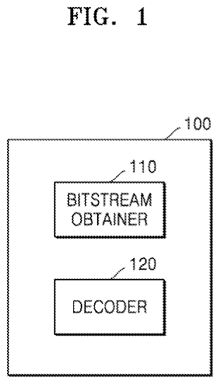

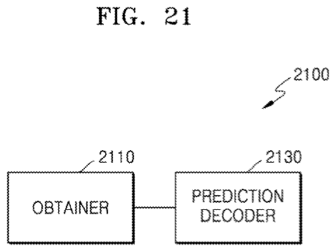

Hereinafter, an image encoding method and apparatus and an image decoding method and apparatus based on coding units and transform units of a tree structure, according to an embodiment, will be described with reference to FIGS. 1 through 20. An image encoding apparatus 200 and an image decoding apparatus 100, which will be described with reference to FIGS. 1 through 20, may respectively include an image encoding apparatus 2800 and an image decoding apparatus 2100, which will be described with reference to FIGS. 21 through 32.

FIG. 1 is a block diagram of the image decoding apparatus 100 capable of decoding an image based on at least one of block shape information and split shape information, according to an embodiment.

Referring to FIG. 1, the image decoding apparatus 100 may include a bitstream obtainer 110 for obtaining certain information such as block shape information and split shape information from a bitstream, and a decoder 120 for decoding an image by using the obtained information. According to an embodiment, when the bitstream obtainer 110 of the image decoding apparatus 100 obtains at least one of block shape information and split shape information, the decoder 120 of the image decoding apparatus 100 may determine at least one coding unit that splits an image based on at least one of the block shape information and the split shape information.

According to an embodiment, the decoder 120 of the image decoding apparatus 100 may determine a shape of a coding unit, based on the block shape information. For example, the block shape information may include information indicating whether a coding unit is a square or a non-square. The decoder 120 may determine a shape of a coding unit by using the block shape information.

According to an embodiment, the decoder 120 may determine in which shape a coding unit is to be split, based on the split shape information. For example, the split shape information may represent information about the shape of at least one coding unit included in a coding unit.

According to an embodiment, the decoder 120 may determine whether a coding unit is to be split or not to be split, according to the split shape information. The split shape information may include information on at least one coding unit included in a coding unit, and, if the split shape information indicates that only one coding unit is included in a coding unit or indicates that the coding unit is not split, the decoder 120 may determine that the coding unit including the split shape information is not split. When the split shape information indicates that a coding unit is split into a plurality of coding units, the decoder 120 may split the coding unit into a plurality of coding units, based on the split shape information.

According to an embodiment, the split shape information may indicate how many coding units the coding unit is to be split into, or in which direction the coding unit is to be split. For example, the split shape information may indicate that the coding unit is split in at least one of a vertical direction and a horizontal direction or is not split.

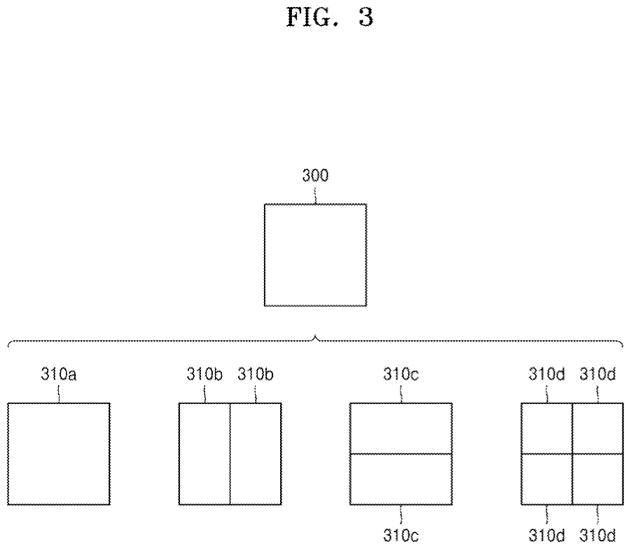

FIG. 3 illustrates a process, performed by the image decoding apparatus 100, of determining at least one coding unit by splitting a current coding unit, according to an embodiment.

A block shape may include 4N×4N, 4N×2N, 2N×4N, 4N×N, or N×4N. Here, N may be a positive integer. Block shape information is information indicating at least one of a shape, direction, a ratio of width and height, or size of a coding unit.

The shape of the coding unit may include a square and a non-square. When the lengths of the width and height of the coding unit are the same, the image decoding apparatus 100 may determine the block shape information of the coding unit to be a square. The image decoding apparatus 100 may determine the shape of the coding unit to be a non-square.

When the lengths of the width and height of the coding unit are different (4N×2N, 2N×4N, 4N×N, or N×4N), the image decoding apparatus 100 may determine the block shape information of the coding unit to be a non-square. When the shape of the coding unit is non-square, the image decoding apparatus 100 may determine the ratio of the width and height among the block shape information of the coding unit to be at least one of 1:2, 2:1, 1:4, 4:1, 1:8, or 8:1. Also, the image decoding apparatus 100 may determine whether the coding unit is in a horizontal direction or a vertical direction, based on the length of the width of the coding unit and the length of the height of the coding unit. Also, the image decoding apparatus 100 may determine the size of the coding unit, based on at least one of the length of the width of the coding unit, the length of the height of the coding unit, or the area of the coding unit.

According to an embodiment, the image decoding apparatus 100 may determine the shape of the coding unit by using the block shape information, and may determine a splitting method of the coding unit by using information about a split shape mode. In other words, a coding unit splitting method indicated by the information about the split shape mode may be determined based on a block shape indicated by the block shape information used by the image decoding apparatus 100.

The image decoding apparatus 100 may obtain the information about the split shape mode from a bitstream. However, embodiments are not limited thereto, and the image decoding apparatus 100 and the image encoding apparatus 200 may obtain information about a pre-agreed split shape mode, based on the block shape information. The image decoding apparatus 100 may obtain the information about the pre-agreed split shape mode with respect to a largest coding unit or a smallest coding unit. For example, the image decoding apparatus 100 may determine the size of the largest coding unit to be 256×256. The image decoding apparatus 100 may determine the information about the pre-agreed split shape mode to be a quad split. The quad split is a split shape mode in which the width and the height of the coding unit are both bisected. The image decoding apparatus 100 may obtain a coding unit of a 128×128 size from the largest coding unit of a 256×256 size, based on the information about the split shape mode. Also, the image decoding apparatus 100 may determine the size of the smallest coding unit to be 4×4. The image decoding apparatus 100 may obtain information about a split shape mode indicating “not to perform splitting” with respect to the smallest coding unit.

According to an embodiment, the image decoding apparatus 100 may use the block shape information indicating that the current coding unit has a square shape. For example, the image decoding apparatus 100 may determine whether not to split a square coding unit, whether to vertically split the square coding unit, whether to horizontally split the square coding unit, or whether to split the square coding unit into four coding units, based on the information about the split shape mode. Referring to FIG. 3, when the block shape information of a current coding unit 300 indicates a square shape, the decoder 120 may determine that a coding unit 310a having the same size as the current coding unit 300 is not split, based on the information about the split shape mode indicating not to perform splitting, or may determine coding units 310b, 310c, 310d, etc. split based on the information about the split shape mode indicating a certain splitting method.

Referring to FIG. 3, according to an embodiment, the image decoding apparatus 100 may determine two coding units 310b obtained by splitting the current coding unit 300 in a vertical direction, based on the information about the split shape mode indicating to perform splitting in a vertical direction. The image decoding apparatus 100 may determine two coding units 310c obtained by splitting the current coding unit 300 in a horizontal direction, based on the information about the split shape mode indicating to perform splitting in a horizontal direction. The image decoding apparatus 100 may determine four coding units 310d obtained by splitting the current coding unit 300 in vertical and horizontal directions, based on the information about the split shape mode indicating to perform splitting in vertical and horizontal directions. However, splitting methods of the square coding unit are not limited to the above-described methods, and the information about the split shape mode may indicate various methods. Certain splitting methods of splitting the square coding unit will be described in detail below in relation to various embodiments.

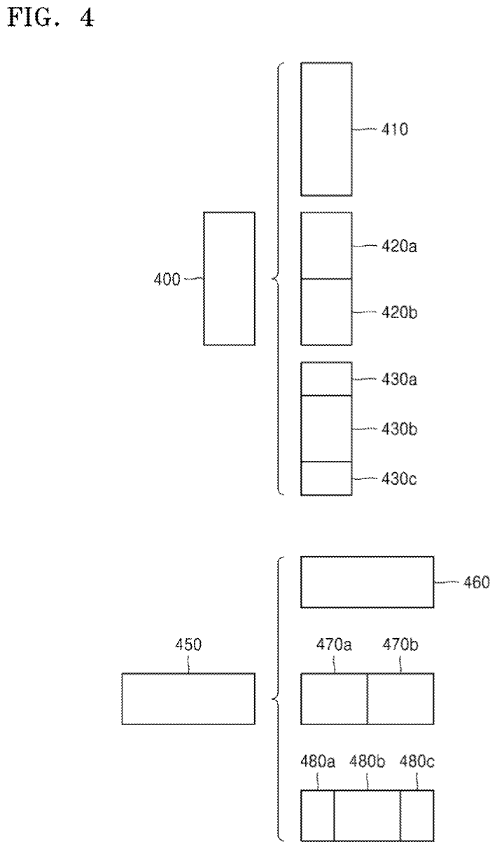

FIG. 4 illustrates a process, performed by the image decoding apparatus 100, of determining at least one coding unit by splitting a non-square coding unit, according to an embodiment.

According to an embodiment, the image decoding apparatus 100 may use block shape information indicating that a current coding unit has a non-square shape. The image decoding apparatus 100 may determine whether not to split the non-square current coding unit or whether to split the non-square current coding unit by using a certain splitting method, based on the information about the split shape mode. Referring to FIG. 4, when the block shape information of a current coding unit 400 or 450 indicates a non-square shape, the image decoding apparatus 100 may determine that a coding unit 410 or 460 having the same size as the current coding unit 400 or 450 is not split, based on the information about the split shape mode indicating not to perform splitting, or determine coding units 420a and 420b, 430a to 430c, 470a and 470b, or 480a to 480c split based on the information about the split shape mode indicating a certain splitting method. Certain splitting methods of splitting a non-square coding unit will be described in detail below in relation to various embodiments.

According to an embodiment, the image decoding apparatus 100 may determine a splitting method of a coding unit by using the information about the split shape mode and, in this case, the information about the split shape mode may indicate the number of one or more coding units generated by splitting a coding unit. Referring to FIG. 4, when the information about the split shape mode indicates to split the current coding unit 400 or 450 into two coding units, the image decoding apparatus 100 may determine two coding units 420a and 420b, or 470a and 470b included in the current coding unit 400 or 450, by splitting the current coding unit 400 or 450 based on the information about the split shape mode.

According to an embodiment, when the image decoding apparatus 100 splits the non-square current coding unit 400 or 450 based on the information about the split shape mode, the image decoding apparatus 100 may consider the location of a long side of the non-square current coding unit 400 or 450 to split a current coding unit. For example, the image decoding apparatus 100 may determine a plurality of coding units by splitting a long side of the current coding unit 400 or 450, in consideration of the shape of the current coding unit 400 or 450.

According to an embodiment, when the information about the split shape mode indicates to split (ternary-split) a coding unit into an odd number of blocks, the image decoding apparatus 100 may determine an odd number of coding units included in the current coding unit 400 or 450. For example, when the information about the split shape mode indicates to split the current coding unit 400 or 450 into three coding units, the image decoding apparatus 100 may split the current coding unit 400 or 450 into three coding units 430a, 430b, and 430c, or 480a, 480b, and 480c.

According to an embodiment, a ratio of the width and height of the current coding unit 400 or 450 may be 4:1 or 1:4. When the ratio of the width and height is 4:1, the block shape information may be a horizontal direction because the length of the width is longer than the length of the height. When the ratio of the width and height is 1:4, the block shape information may be a vertical direction because the length of the width is shorter than the length of the height. The image decoding apparatus 100 may determine to split a current coding unit into the odd number of blocks, based on the information about the split shape mode. Also, the image decoding apparatus 100 may determine a split direction of the current coding unit 400 or 450, based on the block shape information of the current coding unit 400 or 450. For example, when the current coding unit 400 is in the vertical direction, the image decoding apparatus 100 may determine the coding units 430a to 430c by splitting the current coding unit 400 in the horizontal direction. Also, when the current coding unit 450 is in the horizontal direction, the image decoding apparatus 100 may determine the coding units 480a to 480c by splitting the current coding unit 450 in the vertical direction.

According to an embodiment, the image decoding apparatus 100 may determine the odd number of coding units included in the current coding unit 400 or 450, and not all the determined coding units may have the same size. For example, a certain coding unit 430b or 480b from among the determined odd number of coding units 430a, 430b, and 430c, or 480a, 480b, and 480c may have a size different from the sizes of the other coding units 430a and 430c, or 480a and 480c. In other words, coding units which may be determined by splitting the current coding unit 400 or 450 may have multiple sizes and, in some cases, all of the odd number of coding units 430a, 430b, and 430c, or 480a, 480b, and 480c may have different sizes.

According to an embodiment, when the information about the split shape mode indicates to split a coding unit into the odd number of blocks, the image decoding apparatus 100 may determine the odd number of coding units included in the current coding unit 400 or 450, and in addition, may put a certain restriction on at least one coding unit from among the odd number of coding units generated by splitting the current coding unit 400 or 450. Referring to FIG. 4, the image decoding apparatus 100 may set a decoding process regarding the coding unit 430b or 480b located at the center among the three coding units 430a, 430b, and 430c or 480a, 480b, and 480c generated by splitting the current coding unit 400 or 450 to be different from that of the other coding units 430a and 430c, or 480a or 480c. For example, the image decoding apparatus 100 may restrict the coding unit 430b or 480b at the center location to be no longer split or to be split only a certain number of times, unlike the other coding units 430a and 430c, or 480a and 480c.

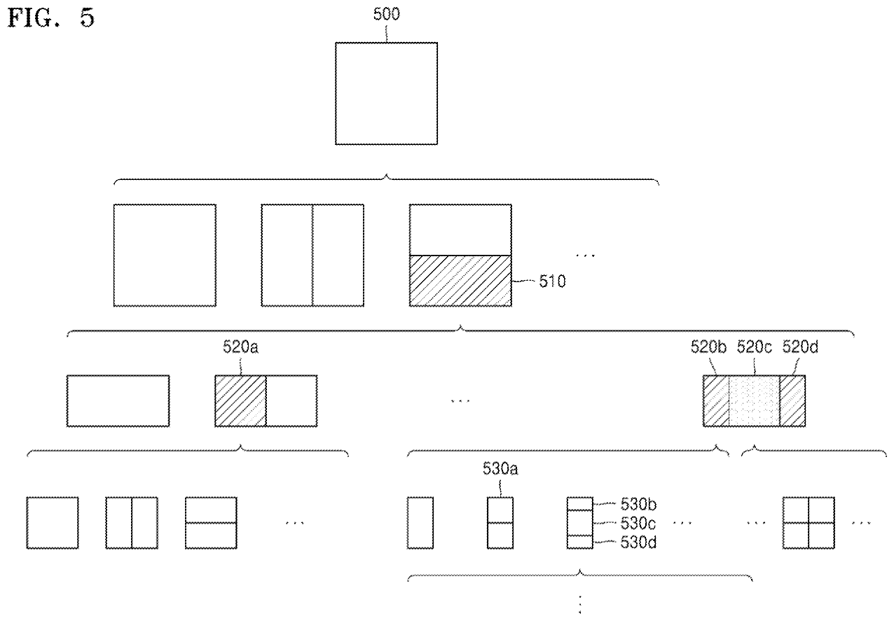

FIG. 5 illustrates a process, performed by the image decoding apparatus 100, of splitting a coding unit based on at least one of block shape information and information about a split shape mode, according to an embodiment.

According to an embodiment, the image decoding apparatus 100 may determine to split or not to split a square first coding unit 500 into coding units, based on at least one of the block shape information and the information about the split shape mode. According to an embodiment, when the information about the split shape mode indicates to split the first coding unit 500 in a horizontal direction, the image decoding apparatus 100 may determine a second coding unit 510 by splitting the first coding unit 500 in a horizontal direction. A first coding unit, a second coding unit, and a third coding unit used according to an embodiment are terms used to understand a relation before and after splitting a coding unit. For example, a second coding unit may be determined by splitting a first coding unit, and a third coding unit may be determined by splitting the second coding unit. It will now be understood that a relationship between the first coding unit, the second coding unit, and the third coding unit follows the above descriptions.

According to an embodiment, the image decoding apparatus 100 may determine to split or not to split the determined second coding unit 510 into coding units, based on at least one of the block shape information and the information about the split shape mode. Referring to FIG. 5, the image decoding apparatus 100 may or may not split the non-square second coding unit 510, which is determined by splitting the first coding unit 500, into one or more third coding units 520a, or 520b, 520c, and 520d based on at least one of the block shape information and the information about the split shape mode. The image decoding apparatus 100 may obtain at least one of the block shape information and the information about the split shape mode, and may obtain a plurality of various-shaped second coding units (e.g., 510) by splitting the first coding unit 500, based on the obtained at least one of the block shape information and the information about the split shape mode, and the second coding unit 510 may be split by using a splitting method of the first coding unit 500 based on at least one of the block shape information and the information about the split shape mode. According to an embodiment, when the first coding unit 500 is split into the second coding units 510 based on at least one of the block shape information and the information about the split shape mode of the first coding unit 500, the second coding unit 510 may also be split into the third coding units 520a, or 520b, 520c, and 520d based on at least one of the block shape information and the information about the split shape mode of the second coding unit 510. In other words, a coding unit may be recursively split based on at least one of the block shape information and the information about the split shape mode of each coding unit. Therefore, a square coding unit may be determined by splitting a non-square coding unit, and a non-square coding unit may be determined by recursively splitting the square coding unit.

Referring to FIG. 5, a certain coding unit from among the odd number of third coding units 520b, 520c, and 520d determined by splitting the non-square second coding unit 510 (e.g., a coding unit at a center location or a non-square coding unit) may be recursively split. According to an embodiment, the non-square third coding unit 520b from among the odd number of third coding units 520b, 520c, and 520d may be split in a horizontal direction into a plurality of fourth coding units. A non-square fourth coding unit 530b or 530d from among a plurality of fourth coding units 530a, 530b, 530c, and 530d may be split into a plurality of coding units again. For example, the non-square fourth coding unit 530b or 530d may be split into the odd number of coding units again. A method that may be used to recursively split a coding unit will be described below in relation to various embodiments.

According to an embodiment, the image decoding apparatus 100 may split each of the third coding units 520a, or 520b, 520c, and 520d into coding units, based on at least one of the block shape information and the information about the split shape mode. In addition, the image decoding apparatus 100 may determine to not to split the second coding unit 510, based on at least one of the block shape information and the information about the split shape mode. According to an embodiment, the image decoding apparatus 100 may split the non-square second coding unit 510 into the odd number of third coding units 520b, 520c, and 520d. The image decoding apparatus 100 may put a certain restriction on a certain third coding unit from among the odd number of third coding units 520b, 520c, and 520d. For example, the image decoding apparatus 100 may restrict the third coding unit 520c at a center location from among the odd number of third coding units 520b, 520c, and 520d to be no longer split or to be split a settable number of times.

Referring to FIG. 5, the image decoding apparatus 100 may restrict the third coding unit 520c, which is at the center location from among the odd number of third coding units 520b, 520c, and 520d included in the non-square second coding unit 510, to be no longer split, to be split by using a certain splitting method (e.g., split into only four coding units or split by using a splitting method of the second coding unit 510), or to be split only a certain number of times (e.g., split only n times (where n>0)). However, the restrictions on the third coding unit 520c at the center location are merely simple embodiments and thus are not limited to the above-described examples, and may include various restrictions for decoding the third coding unit 520c at the center location differently from the other third coding units 520b and 520d.

According to an embodiment, the image decoding apparatus 100 may obtain at least one of the block shape information and the information about the split shape mode, which are used to split a current coding unit, from a certain location in the current coding unit.

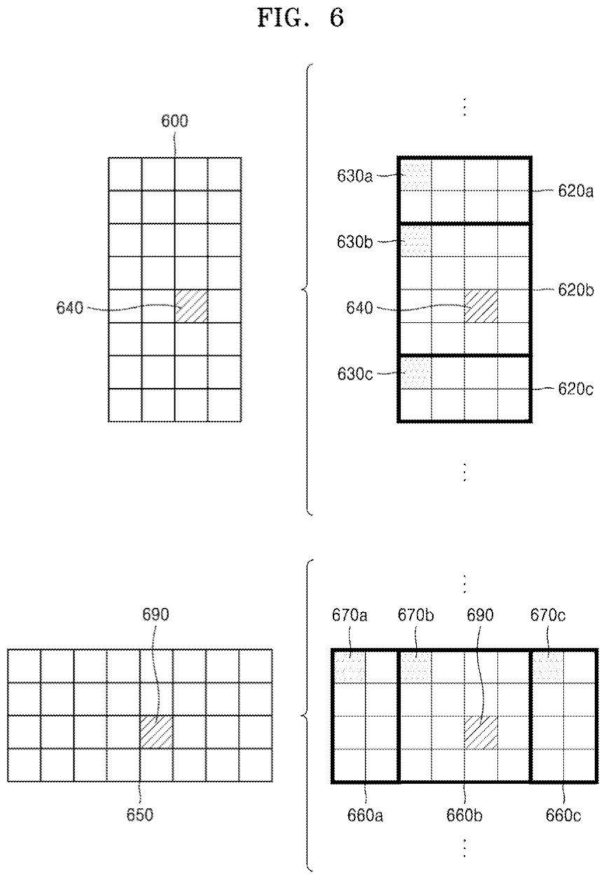

FIG. 6 illustrates a method, performed by the image decoding apparatus 100, of determining a certain coding unit from among an odd number of coding units, according to an embodiment.

Referring to FIG. 6, at least one of block shape information and information about a split shape mode of a current coding unit 600 or 650 may be obtained from a sample at a certain location (e.g., a sample 640 or 690 at a center location) from among a plurality of samples included in the current coding unit 600 or 650. However, the certain location in the current coding unit 600, from which at least one of the block shape information and the information about the split shape mode may be obtained, is not limited to the center location in FIG. 6, and may include various locations included in the current coding unit 600 (e.g., top, bottom, left, right, upper left, lower left, upper right, and lower right locations). The image decoding apparatus 100 may obtain at least one of the block shape information and the information about the split shape mode from the certain location and may determine to split or not to split the current coding unit into various-shaped and various-sized coding units.

According to an embodiment, when the current coding unit is split into a certain number of coding units, the image decoding apparatus 100 may select one of the coding units. Various methods may be used to select one of a plurality of coding units, as will be described below in relation to various embodiments.

According to an embodiment, the image decoding apparatus 100 may split the current coding unit into a plurality of coding units, and may determine a coding unit at a certain location.

According to an embodiment, the image decoding apparatus 100 may use information indicating respective locations of the odd number of coding units, to determine a coding unit at a center location from among the odd number of coding units. Referring to FIG. 6, the image decoding apparatus 100 may determine an odd number of coding units 620a, 620b, and 620c or an odd number of coding units 660a, 660b, and 660c by splitting the current coding unit 600 or the current coding unit 650, respectively. The image decoding apparatus 100 may determine the middle coding unit 620b or the middle coding unit 660b by using information about the locations of the odd number of coding units 620a, 620b, and 620c or the odd number of coding units 660a, 660b, and 660c. For example, the image decoding apparatus 100 may determine the coding unit 620b at the center location by determining the respective locations of the coding units 620a, 620b, and 620c based on information indicating locations of certain samples included in the coding units 620a, 620b, and 620c. In detail, the image decoding apparatus 100 may determine the coding unit 620b at the center location by determining the respective locations of the coding units 620a, 620b, and 620c based on information indicating respective locations of upper left samples 630a, 630b, and 630c of the coding units 620a, 620b, and 620c.

According to an embodiment, the information indicating the respective locations of the upper left samples 630a, 630b, and 630c, which are included in the coding units 620a, 620b, and 620c, respectively, may include information about respective locations or coordinates of the coding units 620a, 620b, and 620c in a picture. According to an embodiment, the information indicating the respective locations of the upper left samples 630a, 630b, and 630c, which are included in the coding units 620a, 620b, and 620c, respectively, may include information indicating respective widths or heights of the coding units 620a, 620b, and 620c included in the current coding unit 600, and the widths or heights may correspond to information indicating differences between the respective coordinates of the coding units 620a, 620b, and 620c in the picture. In other words, the image decoding apparatus 100 may determine the coding unit 620b at the center location by directly using the information about the locations or coordinates of the coding units 620a, 620b, and 620c in the picture, or by using the information about the widths or heights of the coding units, which correspond to the difference values between the coordinates.

According to an embodiment, information indicating the location of the upper left sample 630a of the upper coding unit 620a may include coordinates (xa, ya), information indicating the location of the upper left sample 630b of the middle coding unit 620b may include coordinates (xb, yb), and information indicating the location of the upper left sample 630c of the lower coding unit 620c may include coordinates (xc, yc). The image decoding apparatus 100 may determine the middle coding unit 620b by using the coordinates of the upper left samples 630a, 630b, and 630c which are included in the coding units 620a, 620b, and 620c, respectively. For example, when the coordinates of the upper left samples 630a, 630b, and 630c are sorted in an ascending or descending order, the coding unit 620b including the coordinates (xb, yb) of the sample 630b at the center location may be determined as a coding unit at a center location from among the coding units 620a, 620b, and 620c determined by splitting the current coding unit 600. However, the coordinates indicating the locations of the upper left samples 630a, 630b, and 630c may include coordinates indicating absolute locations in the picture, or may use coordinates (dxb, dyb) that is information indicating a relative location of the upper left sample 630b of the middle coding unit 620b and coordinates (dxc, dyc) that is information indicating a relative location of the upper left sample 630c of the lower coding unit 620c with reference to the location of the upper left sample 630a of the upper coding unit 620a. A method of determining a coding unit at a certain location by using coordinates of a sample included in the coding unit, as information indicating a location of the sample, is not limited to the above-described method, and may include various arithmetic methods capable of using the coordinates of the sample.

According to an embodiment, the image decoding apparatus 100 may split the current coding unit 600 into a plurality of coding units 620a, 620b, and 620c, and may select one of the coding units 620a, 620b, and 620c based on a certain criterion. For example, the image decoding apparatus 100 may select the coding unit 620b, which has a size different from that of the others, from among the coding units 620a, 620b, and 620c.

According to an embodiment, the image decoding apparatus 100 may determine the width or height of each of the coding units 620a, 620b, and 620c by using the coordinates (xa, ya) that is the information indicating the location of the upper left sample 630a of the upper coding unit 620a, the coordinates (xb, yb) that is the information indicating the location of the upper left sample 630b of the middle coding unit 620b, and the coordinates (xc, yc) that is the information indicating the location of the upper left sample 630c of the lower coding unit 620c. The image decoding apparatus 100 may determine the respective sizes of the coding units 620a, 620b, and 620c by using the coordinates (xa, ya), (xb, yb), and (xc, yc) indicating the respective locations of the coding units 620a, 620b, and 620c. According to an embodiment, the image decoding apparatus 100 may determine the width of the upper coding unit 620a to be the width of the current coding unit 600. The image decoding apparatus 100 may determine the height of the upper coding unit 620a to be yb-ya. According to an embodiment, the image decoding apparatus 100 may determine the width of the middle coding unit 620b to be the width of the current coding unit 600. The image decoding apparatus 100 may determine the height of the middle coding unit 620b to be yc-yb. According to an embodiment, the image decoding apparatus 100 may determine the width or height of the lower coding unit 620c by using the width or height of the current coding unit 600 and the widths or heights of the upper and middle coding units 620a and 620b. The image decoding apparatus 100 may determine a coding unit having a different size from that of the others, based on the determined widths and heights of the coding units 620a to 620c. Referring to FIG. 6, the image decoding apparatus 100 may determine the middle coding unit 620b, which has a size different from the size of the upper and lower coding units 620a and 620c, as the coding unit at the certain location. However, the above-described method, performed by the image decoding apparatus 100, of determining a coding unit having a size different from the size of the other coding units merely corresponds to an example of determining a coding unit at a certain location by using the sizes of coding units, which are determined based on the coordinates of samples, and thus various methods of determining a coding unit at a certain location by comparing the sizes of coding units, which are determined based on coordinates of certain samples, may be used.

The image decoding apparatus 100 may determine the width or height of each of the coding units 660a, 660b, and 660c by using the coordinates (xd, yd) that are information indicating the location of a upper left sample 670a of the left coding unit 660a, the coordinates (xe, ye) that are information indicating the location of a upper left sample 670b of the middle coding unit 660b, and the coordinates (xf, yf) that are information indicating a location of the upper left sample 670c of the right coding unit 660c. The image decoding apparatus 100 may determine the respective sizes of the coding units 660a, 660b, and 660c by using the coordinates (xd, yd), (xe, ye), and (xf, yf) indicating the respective locations of the coding units 660a, 660b, and 660c.

According to an embodiment, the image decoding apparatus 100 may determine the width of the left coding unit 660a to be xe-xd. The image decoding apparatus 100 may determine the height of the left coding unit 660a to be the height of the current coding unit 650. According to an embodiment, the image decoding apparatus 100 may determine the width of the middle coding unit 660b to be xf-xe. The image decoding apparatus 100 may determine the height of the middle coding unit 660b to be the height of the current coding unit 650. According to an embodiment, the image decoding apparatus 100 may determine the width or height of the right coding unit 660c by using the width or height of the current coding unit 650 and the widths or heights of the left and middle coding units 660a and 660b. The image decoding apparatus 100 may determine a coding unit having a different size from that of the others, based on the determined widths and heights of the coding units 660a to 660c. Referring to FIG. 6, the image decoding apparatus 100 may determine the middle coding unit 660b, which has a size different from the sizes of the left and right coding units 660a and 660c, as the coding unit at the certain location. However, the above-described method, performed by the image decoding apparatus 100, of determining a coding unit having a size different from the size of the other coding units merely corresponds to an example of determining a coding unit at a certain location by using the sizes of coding units, which are determined based on the coordinates of samples, and thus various methods of determining a coding unit at a certain location by comparing the sizes of coding units, which are determined based on coordinates of certain samples, may be used.

However, locations of samples considered to determine locations of coding units are not limited to the above-described upper left locations, and information about locations of arbitrary samples included in the coding units may be used.

According to an embodiment, the image decoding apparatus 100 may select a coding unit at a certain location from among an odd number of coding units determined by splitting the current coding unit, considering the shape of the current coding unit. For example, when the current coding unit has a non-square shape, a width of which is longer than a height, the image decoding apparatus 100 may determine the coding unit at the certain location in a horizontal direction. That is, the image decoding apparatus 100 may determine one of coding units at different locations in a horizontal direction and put a restriction on the coding unit. When the current coding unit has a non-square shape, a height of which is longer than a width, the image decoding apparatus 100 may determine the coding unit at the certain location in a vertical direction. In other words, the image decoding apparatus 100 may determine one of coding units at different locations in a vertical direction and may put a restriction on the coding unit.

According to an embodiment, the image decoding apparatus 100 may use information indicating respective locations of an even number of coding units, to determine the coding unit at the certain location from among the even number of coding units. The image decoding apparatus 100 may determine an even number of coding units by splitting (binary-splitting) the current coding unit, and may determine the coding unit at the certain location by using the information about the locations of the even number of coding units. An operation related thereto may correspond to the operation of determining a coding unit at a certain location (e.g., a center location) from among an odd number of coding units, which has been described in detail above in relation to FIG. 6, and thus detailed descriptions thereof are not provided here.

According to an embodiment, when a non-square current coding unit is split into a plurality of coding units, certain information about a coding unit at a certain location may be used in a splitting operation to determine the coding unit at the certain location from among the plurality of coding units. For example, the image decoding apparatus 100 may use at least one of block shape information and information about a split shape mode, which is stored in a sample included in a middle coding unit, in a splitting operation to determine a coding unit at a center location from among the plurality of coding units determined by splitting the current coding unit.

Referring to FIG. 6, the image decoding apparatus 100 may split the current coding unit 600 into the plurality of coding units 620a, 620b, and 620c based on at least one of the block shape information and the information about the split shape mode, and may determine the coding unit 620b at a center location from among the plurality of the coding units 620a, 620b, and 620c. Furthermore, the image decoding apparatus 100 may determine the coding unit 620b at the center location, in consideration of a location from which at least one of the block shape information and the information about the split shape mode is obtained. In other words, at least one of the block shape information and the information about the split shape mode of the current coding unit 600 may be obtained from the sample 640 at a center location of the current coding unit 600, and, when the current coding unit 600 is split into the plurality of coding units 620a, 620b, and 620c based on at least one of the block shape information and the information about the split shape mode, the coding unit 620b including the sample 640 may be determined as the coding unit at the center location. However, information used to determine the coding unit at the center location is not limited to at least one of the block shape information and the information about the split shape mode, and various types of information may be used to determine the coding unit at the center location.

According to an embodiment, certain information for identifying the coding unit at the certain location may be obtained from a certain sample included in a coding unit to be determined. Referring to FIG. 6, the image decoding apparatus 100 may use at least one of the block shape information and the information about the split shape mode, which is obtained from a sample at a certain location in the current coding unit 600 (e.g., a sample at a center location of the current coding unit 600) to determine a coding unit at a certain location from among the plurality of the coding units 620a, 620b, and 620c determined by splitting the current coding unit 600 (e.g., a coding unit at a center location from among a plurality of split coding units). In other words, the image decoding apparatus 100 may determine the sample at the certain location by considering a block shape of the current coding unit 600, determine the coding unit 620b including a sample, from which certain information (e.g., at least one of the block shape information and the information about the split shape mode) may be obtained, from among the plurality of coding units 620a, 620b, and 620c determined by splitting the current coding unit 600, and may put a certain restriction on the coding unit 620b. Referring to FIG. 6, according to an embodiment, the image decoding apparatus 100 may determine the sample 640 at the center location of the current coding unit 600 as the sample from which the certain information may be obtained, and may put a certain restriction on the coding unit 620b including the sample 640, in a decoding operation. However, the location of the sample from which the certain information may be obtained is not limited to the above-described location, and may include arbitrary locations of samples included in the coding unit 620b to be determined for a restriction.

According to an embodiment, the location of the sample from which the certain information may be obtained may be determined based on the shape of the current coding unit 600. According to an embodiment, the block shape information may indicate whether the current coding unit has a square or non-square shape, and the location of the sample from which the certain information may be obtained may be determined based on the shape. For example, the image decoding apparatus 100 may determine a sample located on a boundary for splitting at least one of a width and height of the current coding unit in half, as the sample from which the certain information may be obtained, by using at least one of information about the width of the current coding unit and information about the height of the current coding unit. As another example, when the block shape information of the current coding unit indicates a non-square shape, the image decoding apparatus 100 may determine one of samples adjacent to a boundary for splitting a long side of the current coding unit in half, as the sample from which the certain information may be obtained.

According to an embodiment, when the current coding unit is split into a plurality of coding units, the image decoding apparatus 100 may use at least one of the block shape information and the information about the split shape mode to determine a coding unit at a certain location from among the plurality of coding units. According to an embodiment, the image decoding apparatus 100 may obtain at least one of the block shape information and the information about the split shape mode from a sample at a certain location in a coding unit, and split the plurality of coding units, which are generated by splitting the current coding unit, by using at least one of the block shape information and the information about the split shape mode, which is obtained from the sample of the certain location in each of the plurality of coding units. In other words, a coding unit may be recursively split based on at least one of the block shape information and the information about the split shape mode, which is obtained from the sample at the certain location included in each coding unit. An operation of recursively splitting a coding unit has been described above in relation to FIG. 5, and thus detailed descriptions thereof will not be provided here.

According to an embodiment, the image decoding apparatus 100 may determine one or more coding units by splitting the current coding unit, and may determine an order of decoding the one or more coding units, based on a certain block (e.g., the current coding unit).

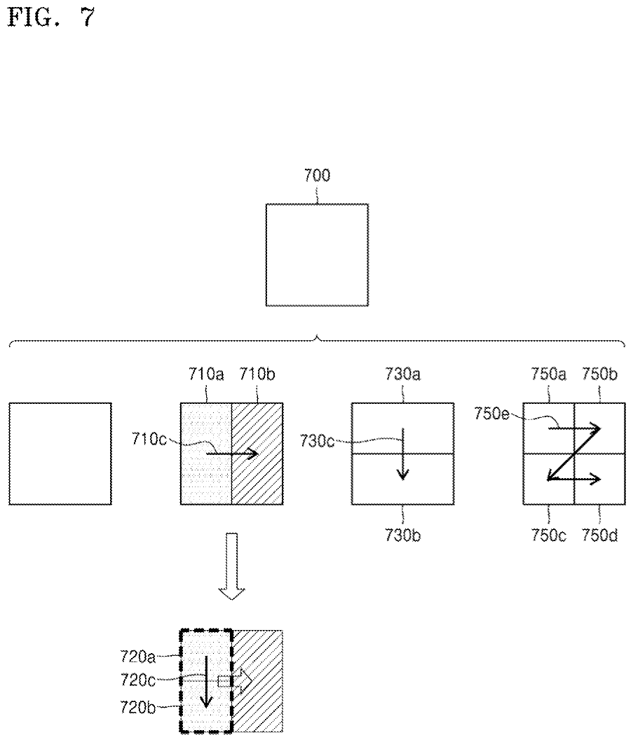

FIG. 7 illustrates an order of processing a plurality of coding units when the image decoding apparatus 100 determines the plurality of coding units by splitting a current coding unit, according to an embodiment.

According to an embodiment, the image decoding apparatus 100 may determine second coding units 710a and 710b by splitting a first coding unit 700 in a vertical direction, determine second coding units 730a and 730b by splitting the first coding unit 700 in a horizontal direction, or determine second coding units 750a to 750d by splitting the first coding unit 700 in vertical and horizontal directions, based on block shape information and information about a split shape mode.

Referring to FIG. 7, the image decoding apparatus 100 may determine to process the second coding units 710a and 710b determined by splitting the first coding unit 700 in a vertical direction, in a horizontal direction order 710c. The image decoding apparatus 100 may determine to process the second coding units 730a and 730b determined by splitting the first coding unit 700 in a horizontal direction, in a vertical direction order 730c. The image decoding apparatus 100 may determine to process the second coding units 750a to 750d determined by splitting the first coding unit 700 in vertical and horizontal directions, in a certain order for processing coding units in a row and then processing coding units in a next row (e.g., in a raster scan order or Z-scan order 750e).

According to an embodiment, the image decoding apparatus 100 may recursively split coding units. Referring to FIG. 7, the image decoding apparatus 100 may determine the plurality of coding units 710a and 710b, 730a and 730b, or 750a to 750d by splitting the first coding unit 700, and recursively split each of the determined plurality of coding units 710b, 730a and 730b, or 750a to 750d. A splitting method of the plurality of coding units 710b, 730a and 730b, or 750a to 750d may correspond to a splitting method of the first coding unit 700. Accordingly, each of the plurality of coding units 710b, 730a and 730b, or 750a to 750d may be independently split into a plurality of coding units. Referring to FIG. 7, the image decoding apparatus 100 may determine the second coding units 710a and 710b by splitting the first coding unit 700 in a vertical direction, and may determine to independently split or not to split each of the second coding units 710a and 710b.

According to an embodiment, the image decoding apparatus 100 may determine third coding units 720a and 720b by splitting the left second coding unit 710a in a horizontal direction, and may not split the right second coding unit 710b.

According to an embodiment, a processing order of coding units may be determined based on an operation of splitting a coding unit. In other words, a processing order of split coding units may be determined based on a processing order of coding units immediately before being split. The image decoding apparatus 100 may determine a processing order of the third coding units 720a and 720b determined by splitting the left second coding unit 710a, independently of the right second coding unit 710b. Because the third coding units 720a and 720b are determined by splitting the left second coding unit 710a in a horizontal direction, the third coding units 720a and 720b may be processed in a vertical direction order 720c. Because the left and right second coding units 710a and 710b are processed in the horizontal direction order 710c, the right second coding unit 710b may be processed after the third coding units 720a and 720b included in the left second coding unit 710a are processed in the vertical direction order 720c. An operation of determining a processing order of coding units based on a coding unit before being split is not limited to the above-described example, and various methods may be used to independently process coding units, which are split and determined to various shapes, in a certain order.

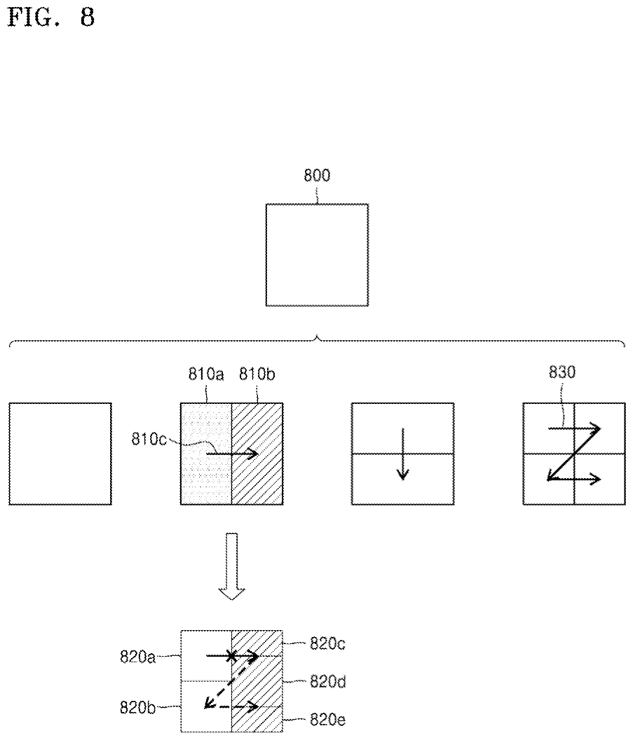

FIG. 8 illustrates a process, performed by the image decoding apparatus 100, of determining that a current coding unit is to be split into an odd number of coding units, when the coding units are not processable in a certain order, according to an embodiment.

According to an embodiment, the image decoding apparatus 100 may determine whether the current coding unit is split into an odd number of coding units, based on obtained block shape information and obtained information about a split shape mode. Referring to FIG. 8, a square first coding unit 800 may be split into non-square second coding units 810a and 810b, and the second coding units 810a and 810b may be independently split into third coding units 820a and 820b, and 820c to 820e. According to an embodiment, the image decoding apparatus 100 may determine the plurality of third coding units 820a and 820b by splitting the left second coding unit 810a in a horizontal direction, and may split the right second coding unit 810b into the odd number of third coding units 820c to 820e.

According to an embodiment, the image decoding apparatus 100 may determine whether any coding unit is split into an odd number of coding units, by determining whether the third coding units 820a and 820b, and 820c to 820e are processable in a certain order. Referring to FIG. 8, the image decoding apparatus 100 may determine the third coding units 820a and 820b, and 820c to 820e by recursively splitting the first coding unit 800. The image decoding apparatus 100 may determine whether any of the first coding unit 800, the second coding units 810a and 810b, and the third coding units 820a and 820b, and 820c to 820e are split into an odd number of coding units, based on at least one of the block shape information and the information about the split shape mode. For example, the right second coding unit 810b among the second coding units 810a and 810b may be split into an odd number of third coding units 820c, 820d, and 820e. A processing order of a plurality of coding units included in the first coding unit 800 may be a certain order (e.g., a Z-scan order 830), and the image decoding apparatus 100 may determine whether the third coding units 820c, 820d, and 820e determined by splitting the right second coding unit 810b into an odd number of coding units satisfy a condition that enables processing in the certain order.

According to an embodiment, the image decoding apparatus 100 may determine whether the third coding units 820a and 820b, and 820c to 820e included in the first coding unit 800 satisfy the condition that enables processing in the certain order, and the condition relates to whether at least one of a width and height of the second coding units 810a and 810b is split in half along a boundary of the third coding units 820a and 820b, and 820c to 820e. For example, the third coding units 820a and 820b determined when the height of the left second coding unit 810a of the non-square shape is split in half may satisfy the condition. It may be determined that the third coding units 820c to 820e do not satisfy the condition because the boundaries of the third coding units 820c to 820e determined when the right second coding unit 810b is split into three coding units are unable to split the width or height of the right second coding unit 810b in half. When the condition is not satisfied as described above, the image decoding apparatus 100 may determine disconnection of a scan order, and may determine that the right second coding unit 810b is split into an odd number of coding units, based on a result of the determination. According to an embodiment, when a coding unit is split into an odd number of coding units, the image decoding apparatus 100 may put a certain restriction on a coding unit at a certain location from among the split coding units. The restriction or the certain location has been described above in relation to various embodiments, and thus detailed descriptions thereof will not be provided herein.

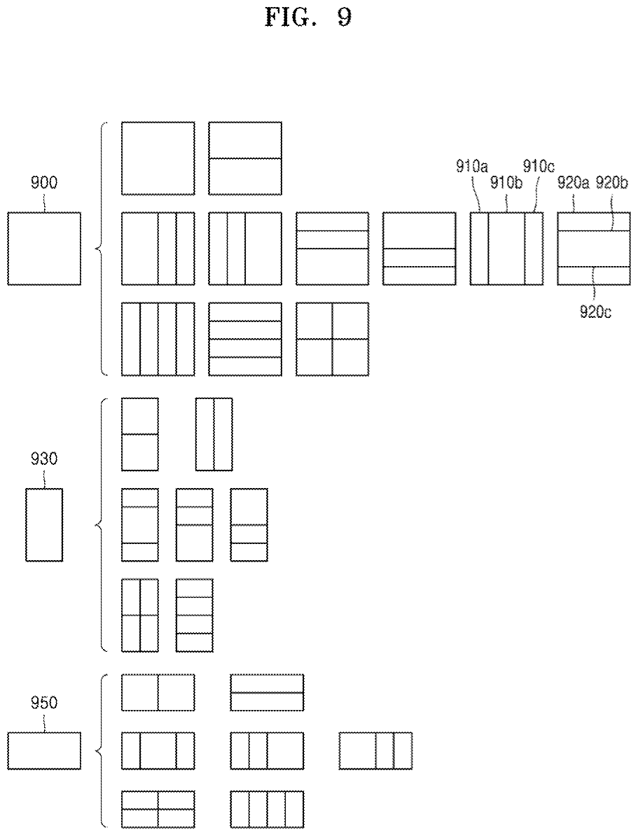

FIG. 9 illustrates a process, performed by the image decoding apparatus 100, of determining at least one coding unit by splitting a first coding unit 900, according to an embodiment.

According to an embodiment, the image decoding apparatus 100 may split the first coding unit 900, based on at least one of block shape information and information about a split shape mode, which is obtained through the bitstream obtainer 110. The square first coding unit 900 may be split into four square coding units, or may be split into a plurality of non-square coding units. For example, referring to FIG. 9, when the block shape information indicates that the first coding unit 900 has a square shape and the information about the split shape mode indicates to split the first coding unit 900 into non-square coding units, the image decoding apparatus 100 may split the first coding unit 900 into a plurality of non-square coding units. In detail, when the information about the split shape mode indicates to determine an odd number of coding units by splitting the first coding unit 900 in a horizontal direction or a vertical direction, the image decoding apparatus 100 may split the square first coding unit 900 into an odd number of coding units, e.g., second coding units 910a, 910b, and 910c determined by splitting the square first coding unit 900 in a vertical direction or second coding units 920a, 920b, and 920c determined by splitting the square first coding unit 900 in a horizontal direction.

According to an embodiment, the image decoding apparatus 100 may determine whether the second coding units 910a, 910b, 910c, 920a, 920b, and 920c included in the first coding unit 900 satisfy a condition for processing in a certain order, and the condition relates to whether at least one of a width and height of the first coding unit 900 is split in half along a boundary of the second coding units 910a, 910b, 910c, 920a, 920b, and 920c. Referring to FIG. 9, because boundaries of the second coding units 910a, 910b, and 910c determined by splitting the square first coding unit 900 in a vertical direction do not split the width of the first coding unit 900 in half, it may be determined that the first coding unit 900 does not satisfy the condition for processing in the certain order. In addition, because boundaries of the second coding units 920a, 920b, and 920c determined by splitting the square first coding unit 900 in a horizontal direction do not split the height of the first coding unit 900 in half, it may be determined that the first coding unit 900 does not satisfy the condition for processing in the certain order. When the condition is not satisfied as described above, the image decoding apparatus 100 may decide disconnection of a scan order, and may determine that the first coding unit 900 is split into an odd number of coding units, based on a result of the decision. According to an embodiment, when a coding unit is split into an odd number of coding units, the image decoding apparatus 100 may put a certain restriction on a coding unit at a certain location from among the split coding units. The restriction or the certain location has been described above in relation to various embodiments, and thus detailed descriptions thereof will not be provided herein.

According to an embodiment, the image decoding apparatus 100 may determine various-shaped coding units by splitting a first coding unit.

Referring to FIG. 9, the image decoding apparatus 100 may split the square first coding unit 900 or a non-square first coding unit 930 or 950 into various-shaped coding units.

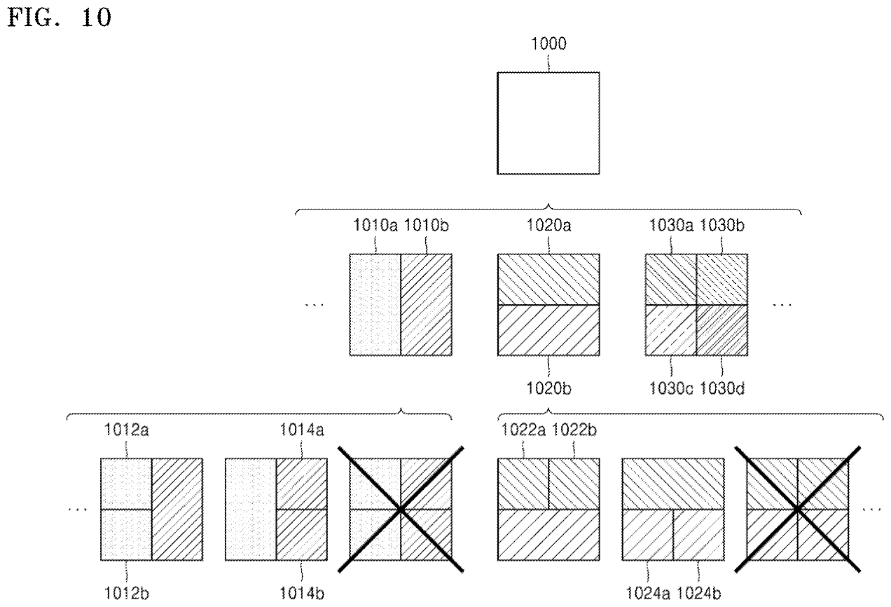

FIG. 10 illustrates that a shape into which a second coding unit is splittable is restricted when the second coding unit having a non-square shape, which is determined as the image decoding apparatus 100 splits a first coding unit 1000, satisfies a certain condition, according to an embodiment.

According to an embodiment, the image decoding apparatus 100 may determine to split the square first coding unit 1000 into non-square second coding units 1010a, and 1010b or 1020a and 1020b, based on at least one of block shape information and information about a split shape mode, which is obtained by the bitstream obtainer 110. The second coding units 1010a and 1010b or 1020a and 1020b may be independently split. As such, the image decoding apparatus 100 may determine to split or not to split each of the second coding units 1010a and 1010b or 1020a and 1020b into a plurality of coding units, based on at least one of block shape information and information about a split shape mode of each of the second coding units 1010a and 1010b or 1020a and 1020b. According to an embodiment, the image decoding apparatus 100 may determine third coding units 1012a and 1012b by splitting, in a horizontal direction, the non-square left second coding unit 1010a, which is determined by splitting the first coding unit 1000 in a vertical direction. However, when the left second coding unit 1010a is split in a horizontal direction, the image decoding apparatus 100 may restrict the right second coding unit 1010b to not be split in a horizontal direction in which the left second coding unit 1010a is split. When third coding units 1014a and 1014b are determined by splitting the right second coding unit 1010b in a same direction, because the left and right second coding units 1010a and 1010b are independently split in a horizontal direction, the third coding units 1012a and 1012b or 1014a and 1014b may be determined. However, this case serves equally as a case in which the image decoding apparatus 100 splits the first coding unit 1000 into four square second coding units 1030a, 1030b, 1030c, and 1030d, based on at least one of the block shape information and the information about the split shape mode, and may be inefficient in terms of image decoding.

According to an embodiment, the image decoding apparatus 100 may determine third coding units 1022a and 1022b or 1024a and 1024b by splitting, in a vertical direction, the non-square second coding unit 1020a or 1020b determined by splitting the first coding unit 1000 in a horizontal direction. However, when a second coding unit (e.g., the upper second coding unit 1020a) is split in a vertical direction, for the above-described reason, the image decoding apparatus 100 may restrict the other second coding unit (e.g., the lower second coding unit 1020b) to not be split in a vertical direction in which the upper second coding unit 1020a is split.

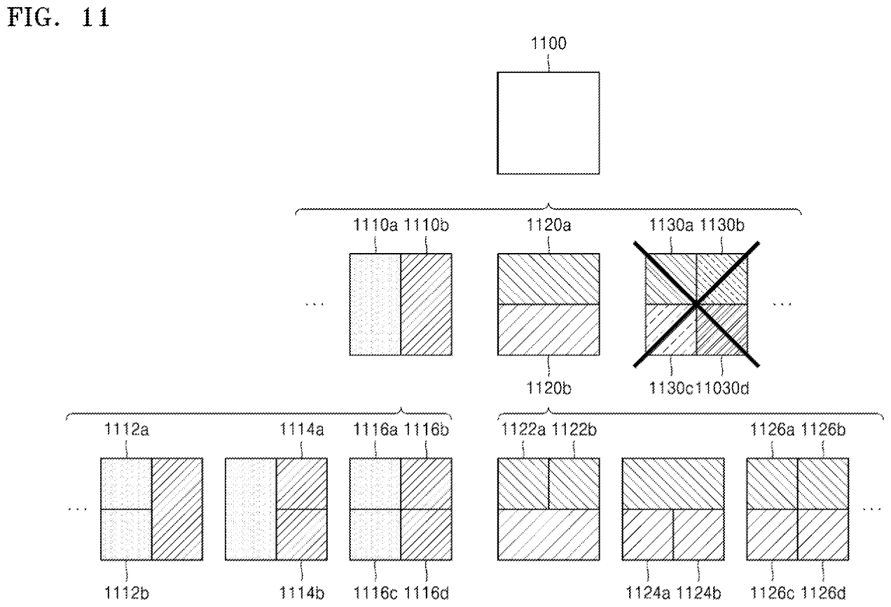

FIG. 11 illustrates a process, performed by the image decoding apparatus 100, of splitting a square coding unit when information about a split shape mode is unable to indicate that the square coding unit is split into four square coding units, according to an embodiment.

According to an embodiment, the image decoding apparatus 100 may determine second coding units 1110a and 1110b or 1120a and 1120b, etc. by splitting a first coding unit 1100, based on at least one of block shape information and the information about the split shape mode. The information about the split shape mode may include information about various methods of splitting a coding unit but, the information about various splitting methods may not include information for splitting a coding unit into four square coding units. According to the information about the split shape mode, the image decoding apparatus 100 may not split the square first coding unit 1100 into four square second coding units 1130a, 1130b, 1130c, and 1130d. The image decoding apparatus 100 may determine the non-square second coding units 1110a and 1110b or 1120a and 1120b, etc., based on the information about the split shape mode.

According to an embodiment, the image decoding apparatus 100 may independently split the non-square second coding units 1110a and 1110b or 1120a and 1120b, etc. Each of the second coding units 1110a and 1110b or 1120a and 1120b, etc. may be recursively split in a certain order, and this splitting method may correspond to a method of splitting the first coding unit 1100, based on at least one of block shape information and the information about the split shape mode.

For example, the image decoding apparatus 100 may determine square third coding units 1112a and 1112b by splitting the left second coding unit 1110a in a horizontal direction, and may determine square third coding units 1114a and 1114b by splitting the right second coding unit 1110b in a horizontal direction. Furthermore, the image decoding apparatus 100 may determine square third coding units 1116a, 1116b, 1116c, and 1116d by splitting both of the left and right second coding units 1110a and 1110b in a horizontal direction. In this case, coding units having the same shape as the four square second coding units 1130a, 1130b, 1130c, and 1130d split from the first coding unit 1100 may be determined.

As another example, the image decoding apparatus 100 may determine square third coding units 1122a and 1122b by splitting the upper second coding unit 1120a in a vertical direction, and may determine square third coding units 1124a and 1124b by splitting the lower second coding unit 1120b in a vertical direction. Furthermore, the image decoding apparatus 100 may determine square third coding units 1126a, 1126b, 1126c, and 1126d by splitting both of the upper and lower second coding units 1120a and 1120b in a vertical direction. In this case, coding units having the same shape as the four square second coding units 1130a, 1130b, 1130c, and 1130d split from the first coding unit 1100 may be determined.

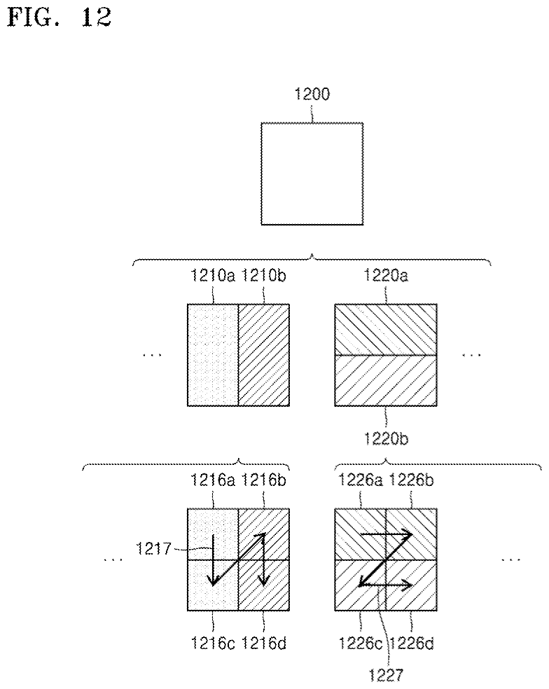

FIG. 12 illustrates that a processing order between a plurality of coding units may be changed depending on a process of splitting a coding unit, according to an embodiment.

According to an embodiment, the image decoding apparatus 100 may split a first coding unit 1200, based on the block shape information and the information about the split shape mode. When the block shape information indicates a square shape and the information about the split shape mode indicates to split the first coding unit 1200 in at least one of horizontal and vertical directions, the image decoding apparatus 100 may determine second coding units 1210a and 1210b or 1220a and 1220b, etc. by splitting the first coding unit 1200. Referring to FIG. 12, the non-square second coding units 1210a and 1210b or 1220a and 1220b determined by splitting the first coding unit 1200 in only a horizontal direction or vertical direction may be independently split based on the block shape information and the information about the split shape mode of each coding unit. For example, the image decoding apparatus 100 may determine third coding units 1216a, 1216b, 1216c, and 1216d by splitting, in a horizontal direction, the second coding units 1210a and 1210b generated by splitting the first coding unit 1200 in a vertical direction, and may determine third coding units 1226a, 1226b, 1226c, and 1226d by splitting, in a vertical direction, the second coding units 1220a and 1220b, which are generated by splitting the first coding unit 1200 in a horizontal direction. An operation of splitting the second coding units 1210a and 1210b or 1220a and 1220b has been described above in relation to FIG. 11, and thus detailed descriptions thereof will not be provided herein.

According to an embodiment, the image decoding apparatus 100 may process coding units in a certain order. An operation of processing coding units in a certain order has been described above in relation to FIG. 7, and thus detailed descriptions thereof will not be provided herein. Referring to FIG. 12, the image decoding apparatus 100 may determine four square third coding units 1216a, 1216b, 1216c, and 1216d, and 1226a, 1226b, 1226c, and 1226d by splitting the square first coding unit 1200. According to an embodiment, the image decoding apparatus 100 may determine processing orders of the third coding units 1216a, 1216b, 1216c, and 1216d, and 1226a, 1226b, 1226c, and 1226d based on a splitting method of the first coding unit 1200.

According to an embodiment, the image decoding apparatus 100 may determine the third coding units 1216a, 1216b, 1216c, and 1216d by splitting, in a horizontal direction, the second coding units 1210a and 1210b generated by splitting the first coding unit 1200 in a vertical direction, and may process the third coding units 1216a, 1216b, 1216c, and 1216d in a processing order 1217 for initially processing the third coding units 1216a and 1216c, which are included in the left second coding unit 1210a, in a vertical direction and then processing the third coding unit 1216b and 1216d, which are included in the right second coding unit 1210b, in a vertical direction.

According to an embodiment, the image decoding apparatus 100 may determine the third coding units 1226a, 1226b, 1226c, and 1226d by splitting, in a vertical direction, the second coding units 1220a and 1220b generated by splitting the first coding unit 1200 in a horizontal direction, and may process the third coding units 1226a, 1226b, 1226c, and 1226d in a processing order 1227 for initially processing the third coding units 1226a and 1226b, which are included in the upper second coding unit 1220a, in a horizontal direction and then processing the third coding unit 1226c and 1226d, which are included in the lower second coding unit 1220b, in a horizontal direction.

Referring to FIG. 12, the square third coding units 1216a, 1216b, 1216c, and 1216d, and 1226a, 1226b, 1226c, and 1226d may be determined by splitting the second coding units 1210a and 1210b, and 1220a and 1220b, respectively. Although the second coding units 1210a and 1210b are determined by splitting the first coding unit 1200 in a vertical direction differently from the second coding units 1220a and 1220b which are determined by splitting the first coding unit 1200 in a horizontal direction, the third coding units 1216a, 1216b, 1216c, and 1216d, and 1226a, 1226b, 1226c, and 1226d split therefrom eventually show same-shaped coding units split from the first coding unit 1200. Accordingly, by recursively splitting a coding unit in different manners based on at least one of the block shape information and the information about the split shape mode, the image decoding apparatus 100 may process a plurality of coding units in different orders even when the coding units are eventually determined to be the same shape.

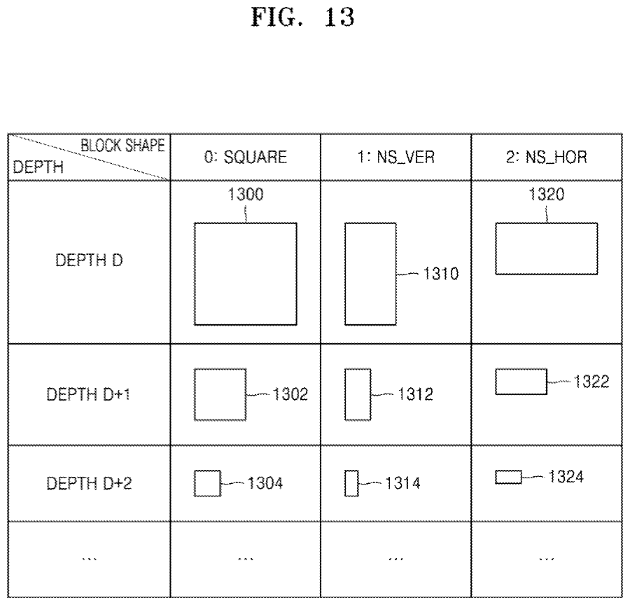

FIG. 13 illustrates a process of determining a depth of a coding unit as a shape and size of the coding unit change, when the coding unit is recursively split such that a plurality of coding units are determined, according to an embodiment.

According to an embodiment, the image decoding apparatus 100 may determine the depth of the coding unit, based on a certain criterion. For example, the certain criterion may be the length of a long side of the coding unit. When the length of a long side of a coding unit before being split is 2n times (n>0) the length of a long side of a split current coding unit, the image decoding apparatus 100 may determine that a depth of the current coding unit is increased from a depth of the coding unit before being split, by n. In the following description, a coding unit having an increased depth is expressed as a coding unit of a lower depth.

Referring to FIG. 13, according to an embodiment, the image decoding apparatus 100 may determine a second coding unit 1302 and a third coding unit 1304 of lower depths by splitting a square first coding unit 1300, based on block shape information indicating a square shape (for example, the block shape information may be expressed as ‘0: SQUARE’). Assuming that the size of the square first coding unit 1300 is 2N×2N, the second coding unit 1302 determined by splitting a width and height of the first coding unit 1300 in ½ may have a size of N×N. Furthermore, the third coding unit 1304 determined by splitting a width and height of the second coding unit 1302 in ½ may have a size of N/2×N/2. In this case, a width and height of the third coding unit 1304 are ¼ times those of the first coding unit 1300. When a depth of the first coding unit 1300 is D, a depth of the second coding unit 1302, the width and height of which are ½ times those of the first coding unit 1300, may be D+1, and a depth of the third coding unit 1304, the width and height of which are ¼ times those of the first coding unit 1300, may be D+2.

According to an embodiment, the image decoding apparatus 100 may determine a second coding unit 1312 or 1322 and a third coding unit 1314 or 1324 of lower depths by splitting a non-square first coding unit 1310 or 1320, based on block shape information indicating a non-square shape (for example, the block shape information may be expressed as ‘1: NS_VER’ indicating a non-square shape, a height of which is longer than a width, or as ‘2: NS_HOR’ indicating a non-square shape, a width of which is longer than a height).

The image decoding apparatus 100 may determine a second coding unit 1302, 1312, or 1322 by splitting at least one of a width and height of the first coding unit 1310 having a size of N×2N. In other words, the image decoding apparatus 100 may determine the second coding unit 1302 having a size of N×N or the second coding unit 1322 having a size of N×N/2 by splitting the first coding unit 1310 in a horizontal direction, or may determine the second coding unit 1312 having a size of N/2×N by splitting the first coding unit 1310 in horizontal and vertical directions.

According to an embodiment, the image decoding apparatus 100 may determine the second coding unit 1302, 1312, or 1322 by splitting at least one of a width and height of the first coding unit 1320 having a size of 2N×N. That is, the image decoding apparatus 100 may determine the second coding unit 1302 having a size of N×N or the second coding unit 1312 having a size of N/2×N by splitting the first coding unit 1320 in a vertical direction, or may determine the second coding unit 1322 having a size of N×N/2 by splitting the first coding unit 1320 in horizontal and vertical directions.

According to an embodiment, the image decoding apparatus 100 may determine a third coding unit 1304, 1314, or 1324 by splitting at least one of a width and height of the second coding unit 1302 having a size of N×N. That is, the image decoding apparatus 100 may determine the third coding unit 1304 having a size of N/2×N/2, the third coding unit 1314 having a size of N/4×N/2, or the third coding unit 1324 having a size of N/2×N/4 by splitting the second coding unit 1302 in vertical and horizontal directions.

According to an embodiment, the image decoding apparatus 100 may determine the third coding unit 1304, 1314, or 1324 by splitting at least one of a width and height of the second coding unit 1312 having a size of N/2×N. That is, the image decoding apparatus 100 may determine the third coding unit 1304 having a size of N/2×N/2 or the third coding unit 1324 having a size of N/2×N/4 by splitting the second coding unit 1312 in a horizontal direction, or may determine the third coding unit 1314 having a size of N/4×N/2 by splitting the second coding unit 1312 in vertical and horizontal directions.

According to an embodiment, the image decoding apparatus 100 may determine the third coding unit 1304, 1314, or 1324 by splitting at least one of a width and height of the second coding unit 1322 having a size of N×N/2. That is, the image decoding apparatus 100 may determine the third coding unit 1304 having a size of N/2×N/2 or the third coding unit 1314 having a size of N/4×N/2 by splitting the second coding unit 1322 in a vertical direction, or may determine the third coding unit 1324 having a size of N/2×N/4 by splitting the second coding unit 1322 in vertical and horizontal directions.

According to an embodiment, the image decoding apparatus 100 may split the square coding unit 1300, 1302, or 1304 in a horizontal or vertical direction. For example, the image decoding apparatus 100 may determine the first coding unit 1310 having a size of N×2N by splitting the first coding unit 1300 having a size of 2N×2N in a vertical direction, or may determine the first coding unit 1320 having a size of 2N×N by splitting the first coding unit 1300 in a horizontal direction. According to an embodiment, when a depth is determined based on the length of the longest side of a coding unit, a depth of a coding unit determined by splitting the first coding unit 1300 having a size of 2N×2N in a horizontal or vertical direction may be the same as the depth of the first coding unit 1300.

According to an embodiment, a width and height of the third coding unit 1314 or 1324 may be ¼ times those of the first coding unit 1310 or 1320. When a depth of the first coding unit 1310 or 1320 is D, a depth of the second coding unit 1312 or 1322, the width and height of which are ½ times those of the first coding unit 1310 or 1320, may be D+1, and a depth of the third coding unit 1314 or 1324, the width and height of which are ¼ times those of the first coding unit 1310 or 1320, may be D+2.

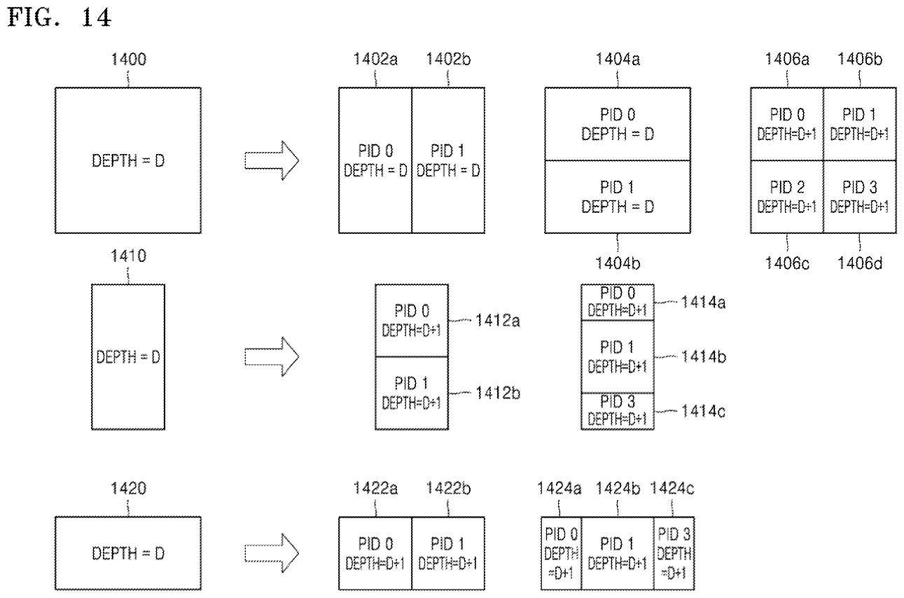

FIG. 14 illustrates depths that are determinable based on shapes and sizes of coding units, and part indexes (PIDs) that are for distinguishing the coding units, according to an embodiment.

According to an embodiment, the image decoding apparatus 100 may determine various-shaped second coding units by splitting a square first coding unit 1400. Referring to FIG. 14, the image decoding apparatus 100 may determine second coding units 1402a and 1402b, 1404a and 1404b, and 1406a, 1406b, 1406c, and 1406d by splitting the first coding unit 1400 in at least one of vertical and horizontal directions based on information about a split shape mode. That is, the image decoding apparatus 100 may determine the second coding units 1402a and 1402b, 1404a and 1404b, and 1406a, 1406b, 1406c, and 1406d, based on the information about the split shape mode of the first coding unit 1400.

According to an embodiment, depths of the second coding units 1402a and 1402b, 1404a and 1404b, and 1406a, 1406b, 1406c, and 1406d, which are determined based on the information about the split shape mode of the square first coding unit 1400, may be determined based on the length of a long side thereof. For example, because the length of a side of the square first coding unit 1400 equals the length of a long side of the non-square second coding units 1402a and 1402b, and 1404a and 1404b, the first coding unit 2100 and the non-square second coding units 1402a and 1402b, and 1404a and 1404b may have the same depth, e.g., D. However, when the image decoding apparatus 100 splits the first coding unit 1400 into the four square second coding units 1406a, 1406b, 1406c, and 1406d, based on the information about the split shape mode, because the length of a side of the square second coding units 1406a, 1406b, 1406c, and 1406d is ½ times the length of a side of the first coding unit 1400, a depth of the second coding units 1406a, 1406b, 1406c, and 1406d may be D+1 which is lower than the depth D of the first coding unit 1400 by 1.

According to an embodiment, the image decoding apparatus 100 may determine a plurality of second coding units 1412a and 1412b, and 1414a, 1414b, and 1414c by splitting a first coding unit 1410, a height of which is longer than a width, in a horizontal direction based on the information about the split shape mode. According to an embodiment, the image decoding apparatus 100 may determine a plurality of second coding units 1422a and 1422b, and 1424a, 1424b, and 1424c by splitting a first coding unit 1420, a width of which is longer than a height, in a vertical direction based on the information about the split shape mode.

According to an embodiment, a depth of the second coding units 1412a and 1412b, and 1414a, 1414b, and 1414c, or 1422a and 1422b, and 1424a, 1424b, and 1424c, which are determined based on the information about the split shape mode of the non-square first coding unit 1410 or 1420, may be determined based on the length of a long side thereof. For example, because the length of a side of the square second coding units 1412a and 1412b is ½ times the length of a side of the non-square first coding unit 1410, a height of which is longer than a width, a depth of the square second coding units 1412a and 1412b is D+1 which is lower than the depth D of the non-square first coding unit 1410 by 1.

Furthermore, the image decoding apparatus 100 may split the non-square first coding unit 1410 into an odd number of second coding units 1414a, 1414b, and 1414c, based on the information about the split shape mode. The odd number of second coding units 1414a, 1414b, and 1414c may include the non-square second coding units 1414a and 1414c and the square second coding unit 1414b. In this case, because the length of a long side of the non-square second coding units 1414a and 1414c and the length of a side of the square second coding unit 1414b are ½ times the length of a side of the first coding unit 1410, a depth of the second coding units 1414a, 1414b, and 1414c may be D+1 which is lower than the depth D of the non-square first coding unit 1410 by 1. The image decoding apparatus 100 may determine depths of coding units split from the non-square first coding unit 1420, a width of which is longer than a height, by using the above-described method of determining depths of coding units split from the first coding unit 1410.

According to an embodiment, the image decoding apparatus 100 may determine PIDs for identifying split coding units, based on a size ratio between the coding units, when an odd number of split coding units do not have equal sizes. Referring to FIG. 14, a coding unit 1414b at a center location among the odd number of split coding units 1414a, 1414b, and 1414c may have a width equal to that of the other coding units 1414a and 1414c and may have a height which is two times that of the other coding units 1414a and 1414c. In other words, in this case, the coding unit 1414b at the center location may include two of the other coding unit 1414a or 1414c. Therefore, when a PID of the coding unit 1414b at the center location is 1 based on a scan order, a PID of the coding unit 1414c located next to the coding unit 1414b may be increased by 2 and thus may be 3. That is, discontinuity in PID values may be present. According to an embodiment, the image decoding apparatus 100 may determine whether an odd number of split coding units do not have equal sizes, based on whether discontinuity is present in PIDs for identifying the split coding units.

According to an embodiment, the image decoding apparatus 100 may determine whether to use a specific splitting method, based on PID values for identifying a plurality of coding units determined by splitting a current coding unit. Referring to FIG. 14, the image decoding apparatus 100 may determine an even number of coding units 1412a and 1412b or an odd number of coding units 1414a, 1414b, and 1414c by splitting the first coding unit 1410 having a rectangular shape, a height of which is longer than a width. The image decoding apparatus 100 may use respective PIDs indicating the plurality of coding units so as to identify the plurality of coding units. According to an embodiment, the PID may be obtained from a sample of a certain location of each coding unit (e.g., an upper left sample).

According to an embodiment, the image decoding apparatus 100 may determine a coding unit at a certain location from among the split coding units, by using the PIDs for distinguishing the coding units. According to an embodiment, when the information about the split shape mode of the first coding unit 1410 having a rectangular shape, a height of which is longer than a width, indicates to split a coding unit into three coding units, the image decoding apparatus 100 may split the first coding unit 1410 into three coding units 1414a, 1414b, and 1414c. The image decoding apparatus 100 may assign a PID to each of the three coding units 1414a, 1414b, and 1414c. The image decoding apparatus 100 may compare respective PIDs of an odd number of split coding units with one another in order to determine a coding unit at a center location from among the odd number of coding units. The image decoding apparatus 100 may determine the coding unit 1414b having a PID corresponding to a middle value among the PIDs of the coding units, as the coding unit at the center location from among the coding units determined by splitting the first coding unit 1410. According to an embodiment, the image decoding apparatus 100 may determine PIDs for distinguishing split coding units, based on a size ratio between the coding units, when the split coding units do not have equal sizes. Referring to FIG. 14, the coding unit 1414b generated by splitting the first coding unit 1410 may have a width equal to that of the other coding units 1414a and 1414c, but may have a height which is two times that of the other coding units 1414a and 1414c. In this case, when the PID of the coding unit 1414b at the center location is 1, the PID of the coding unit 1414c located next to the coding unit 1414b may be increased by 2 and thus may be 3. When the PID is not uniformly increased as described above, the image decoding apparatus 100 may determine that a coding unit is split into a plurality of coding units including a coding unit having a size different from that of the other coding units. According to an embodiment, when the information about the split shape mode indicates to split a coding unit into an odd number of coding units, the image decoding apparatus 100 may split a current coding unit in such a manner that a coding unit at a certain location from among an odd number of coding units (e.g., a coding unit at a center location) has a size different from that of the other coding units. In this case, the image decoding apparatus 100 may determine the coding unit located at the center location and having a different size, by using the PI Ds of the coding units. However, the PIDs and the size or location of the coding unit of the certain location are not limited to the above-described examples, and various PI Ds and various locations and sizes of coding units may be used.

According to an embodiment, the image decoding apparatus 100 may use a certain data unit where a coding unit starts to be recursively split.

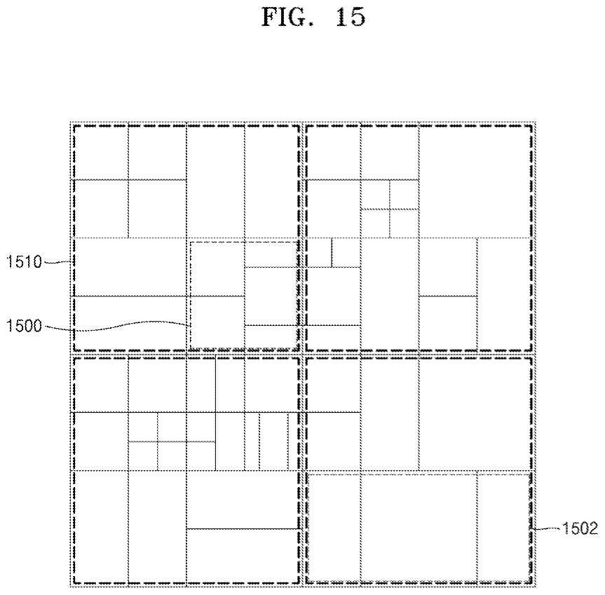

FIG. 15 illustrates that a plurality of coding units are determined based on a plurality of certain data units included in a picture, according to an embodiment.

According to an embodiment, a certain data unit may be defined as a data unit where a coding unit starts to be recursively split by using at least one of the block shape information and the information about the split shape mode. That is, the certain data unit may correspond to a coding unit of an uppermost depth, which is used to determine a plurality of coding units split from a current picture. In the following descriptions, for convenience of explanation, the certain data unit is referred to as a reference data unit.

According to an embodiment, the reference data unit may have a certain size and a certain shape. According to an embodiment, the reference data unit may include M×N samples. Herein, M and N may be equal to each other, and may be integers expressed as powers of 2. That is, the reference data unit may have a square or non-square shape, and may be split into an integer number of coding units.

According to an embodiment, the image decoding apparatus 100 may split the current picture into a plurality of reference data units. According to an embodiment, the image decoding apparatus 100 may split the plurality of reference data units split from the current picture, by using the information about the split shape mode of each of the plurality of reference data units. The operation of splitting the reference data unit may correspond to a splitting operation using a quadtree structure.

According to an embodiment, the image decoding apparatus 100 may previously determine a minimum size allowed for the reference data units included in the current picture. Accordingly, the image decoding apparatus 100 may determine reference data units having various sizes equal to or greater than the minimum size, and may determine one or more coding units by using the block shape information and the information about the split shape mode with reference to the determined reference data units.

Referring to FIG. 15, the image decoding apparatus 100 may use a square reference coding unit 1500 or a non-square reference coding unit 1502. According to an embodiment, the shape and size of a reference coding unit may be determined based on various data units capable of including one or more reference coding units (e.g., a sequence, a picture, a slice, a slice segment, a largest coding units, and the like).

According to an embodiment, the bitstream obtainer 110 of the image decoding apparatus 100 may obtain, from a bitstream, at least one of reference coding unit shape information and reference coding unit size information for each of the various data units. An operation of splitting the square reference coding unit 1500 into one or more coding units has been described above in relation to the operation of splitting the current coding unit 300 of FIG. 3, and an operation of splitting the non-square reference coding unit 1502 into one or more coding units has been described above in relation to the operation of splitting the current coding unit 400 or 450 of FIG. 4. Thus, detailed descriptions thereof will not be provided herein.

According to an embodiment, the image decoding apparatus 100 may use a PID for identifying the size and shape of reference coding units, to determine the size and shape of reference coding units according to some data units previously determined based on a certain condition. That is, the bitstream obtainer 110 may obtain, from the bitstream, only the PID for identifying the size and shape of reference coding units, for each slice, slice segment, or largest coding unit which is a data unit satisfying a certain condition (e.g., a data unit having a size equal to or smaller than a slice) among the various data units (e.g., a sequence, a picture, a slice, a slice segment, a largest coding unit, and the like). The image decoding apparatus 100 may determine the size and shape of reference data units for each data unit that satisfies the certain condition, by using the PID. When the reference coding unit shape information and the reference coding unit size information are obtained and used from the bitstream for each data unit having a relatively small size, efficiency of using the bitstream may not be high, and therefore, only the PID may be obtained and used instead of directly obtaining the reference coding unit shape information and the reference coding unit size information. In this case, at least one of the size and shape of reference coding units corresponding to the PID for identifying the size and shape of reference coding units may be previously determined. That is, the image decoding apparatus 100 may determine at least one of the size and shape of reference coding units included in a data unit serving as a basis for obtaining the PID, by selecting the previously determined at least one of the size and shape of reference coding units according to the PID.

According to an embodiment, the image decoding apparatus 100 may use one or more reference coding units included in a largest coding unit. That is, a largest coding unit split from an image may include one or more reference coding units, and coding units may be determined by recursively splitting each reference coding unit. According to an embodiment, at least one of a width and height of the largest coding unit may be integer times at least one of the width and height of each reference coding unit. According to an embodiment, the size of reference coding units may be obtained by splitting the largest coding unit n times based on a quadtree structure. That is, the image decoding apparatus 100 may determine the reference coding units by splitting the largest coding unit n times based on a quadtree structure, and may split the reference coding unit based on at least one of the block shape information and the information about the split shape mode according to various embodiments.

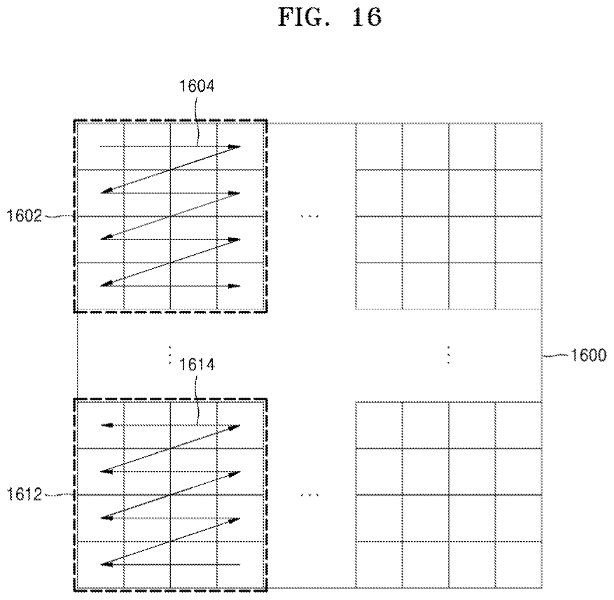

FIG. 16 illustrates a processing block serving as a criterion for determining a determination order of reference coding units included in a picture 1600, according to an embodiment.

According to an embodiment, the image decoding apparatus 100 may determine one or more processing blocks split from a picture. The processing block is a data unit including one or more reference coding units split from an image, and the one or more reference coding units included in the processing block may be determined according to a specific order. That is, a determination order of one or more reference coding units determined in each processing block may correspond to one of various types of orders for determining reference coding units, and may vary depending on the processing block. The determination order of reference coding units, which is determined with respect to each processing block, may be one of various orders, e.g., raster scan order, Z-scan, N-scan, up-right diagonal scan, horizontal scan, and vertical scan, but is not limited to the aforementioned scan orders.

According to an embodiment, the image decoding apparatus 100 may obtain processing block size information and may determine the size of one or more processing blocks included in the image. The image decoding apparatus 100 may obtain the processing block size information from a bitstream and may determine the size of one or more processing blocks included in the image. The size of processing blocks may be a certain size of data units, which is indicated by the processing block size information.

According to an embodiment, the bitstream obtainer 110 of the image decoding apparatus 100 may obtain the processing block size information from the bitstream for each specific data unit. For example, the processing block size information may be obtained from the bitstream in a data unit such as an image, sequence, picture, slice, or slice segment. That is, the bitstream obtainer 110 may obtain the processing block size information from the bitstream according to each of the various data units, and the image decoding apparatus 100 may determine the size of one or more processing blocks, which are split from the picture, by using the obtained processing block size information. The size of the processing blocks may be integer times that of a reference coding unit.

According to an embodiment, the image decoding apparatus 100 may determine the size of processing blocks 1602 and 1612 included in the picture 1600. For example, the image decoding apparatus 100 may determine the size of processing blocks, based on the processing block size information obtained from the bitstream. Referring to FIG. 16, according to an embodiment, the image decoding apparatus 100 may determine a width of the processing blocks 1602 and 1612 to be four times the width of the reference coding units, and may determine a height of the processing blocks 1602 and 1612 to be four times the height of the reference coding units. The image decoding apparatus 100 may determine a determination order of one or more reference coding units in one or more processing blocks.

According to an embodiment, the image decoding apparatus 100 may determine the processing blocks 1602 and 1612, which are included in the picture 1600, based on the size of processing blocks, and may determine a determination order of one or more reference coding units included in the processing blocks 1602 and 1612. According to an embodiment, determination of reference coding units may include determination of the size of the reference coding units.

According to an embodiment, the image decoding apparatus 100 may obtain, from the bitstream, determination order information of one or more reference coding units included in one or more processing blocks, and may determine a determination order of one or more reference coding units, based on the obtained determination order information. The determination order information may be defined as an order or direction for determining the reference coding units in the processing block. That is, the determination order of reference coding units may be independently determined for each processing block.

According to an embodiment, the image decoding apparatus 100 may obtain, from the bitstream, the determination order information of reference coding units for each specific data unit. For example, the bitstream obtainer 110 may obtain the determination order information of reference coding units from the bitstream for each data unit such as an image, sequence, picture, slice, slice segment, or processing block. Because the determination order information of reference coding units indicates an order for determining reference coding units in a processing block, the determination order information may be obtained for each specific data unit including an integer number of processing blocks.

According to an embodiment, the image decoding apparatus 100 may determine one or more reference coding units based on the determined determination order.

According to an embodiment, the bitstream obtainer 110 may obtain from the bitstream the determination order information of reference coding units, as information related to the processing blocks 1602 and 1612, and the image decoding apparatus 100 may determine a determination order of one or more reference coding units included in the processing blocks 1602 and 1612 and determine one or more reference coding units, which are included in the picture 1600, based on the determination order. Referring to FIG. 16, the image decoding apparatus 100 may determine determination orders 1604 and 1614 of one or more reference coding units related to the processing blocks 1602 and 1612, respectively. For example, when the determination order information of reference coding units is obtained for each processing block, different types of the determination order information of reference coding units may be obtained for the processing blocks 1602 and 1612. When the determination order 1604 of reference coding units in the processing block 1602 is a raster scan order, reference coding units included in the processing block 1602 may be determined according to a raster scan order. On the contrary, when the determination order 1614 of reference coding units in the other processing block 1612 is a backward raster scan order, reference coding units included in the processing block 1612 may be determined according to the backward raster scan order.

According to an embodiment, the image decoding apparatus 100 may decode the determined one or more reference coding units. The image decoding apparatus 100 may decode an image, based on the reference coding units determined through the above-described embodiments. A method of decoding the reference coding units may include various image decoding methods.

According to an embodiment, the image decoding apparatus 100 may obtain block shape information indicating the shape of a current coding unit or the information about the split shape mode indicating a splitting method of the current coding unit, from the bitstream, and may use the obtained information. The block shape information or the information about the split shape mode may be included in the bitstream related to various data units. For example, the image decoding apparatus 100 may use the block shape information or the information about the split shape mode included in a sequence parameter set, a picture parameter set, a video parameter set, a slice header, or a slice segment header. Furthermore, the image decoding apparatus 100 may obtain, from the bitstream, a syntax element corresponding to the block shape information or the information about the split shape mode, for each largest coding unit, each reference coding unit, or each processing block, and may use the obtained syntax element.

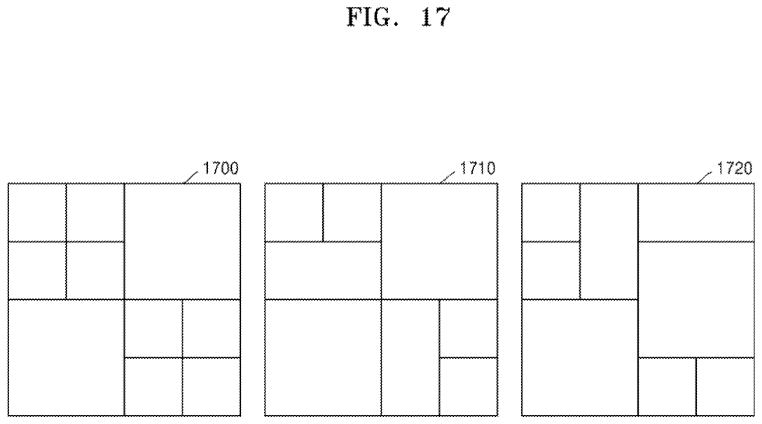

FIG. 17 illustrates coding units that may be determined for each picture when a combination of shapes into which a coding unit is splittable is different for each picture, according to an embodiment.

Referring to FIG. 17, the image decoding apparatus 100 may determine a combination of split shapes into which a coding unit is splittable to be different for each picture. For example, the image decoding apparatus 100 may decode an image by using a picture 1700 splittable into 4 coding units, a picture 1710 splittable into 2 or 4 coding units, and a picture 1720 splittable into 2, 3, or 4 coding units, among one or more pictures included in the image. The image decoding apparatus 100 may only use split shape information indicating a split into 4 square coding units, in order to split the picture 1700 into a plurality of coding units. The image decoding apparatus 100 may only use split shape information indicating a split into 2 or 4 coding units, in order to split the picture 1710. The image decoding apparatus 100 may only use split shape information indicating a split into 2, 3, or 4 coding units, in order to split the picture 1720. Because the above combinations of split shapes are only embodiments for describing operations of the image decoding apparatus 100, the combinations of split shapes should not be interpreted limitedly to the embodiments and it should be interpreted that various types of combinations of split shapes may be used for each of certain data units.

According to an embodiment, the bitstream obtainer 110 of the image decoding apparatus 100 may obtain a bitstream including an index indicating a combination of split shape information, for each of certain data units (for example, a sequence, a picture, or slice). For example, the bitstream obtainer 110 may obtain an index indicating a combination of split shape information from a sequence parameter set, a picture parameter set, or a slice header. The image decoding apparatus 100 may determine a combination of split shapes of coding units into which a certain data unit is splittable by using the obtained index, and accordingly, different combinations of split shapes may be used for each of certain data units.

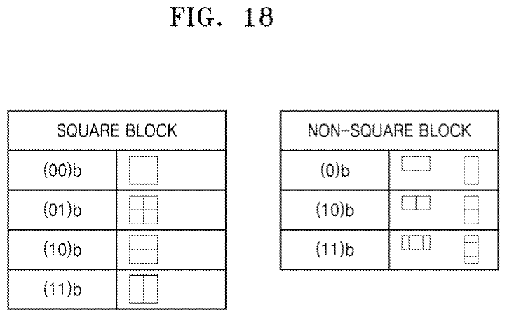

FIG. 18 illustrates various shapes of a coding unit that may be determined based on split shape information representable in a binary code, according to an embodiment.

According to an embodiment, the image decoding apparatus 100 may split a coding unit into various shapes by using block shape information and split shape information obtained via the bitstream obtainer 110. Splittable shapes of a coding unit may correspond to various shapes including the shapes described above through the above-described embodiments.

Referring to FIG. 18, the image decoding apparatus 100 may split a square coding unit in at least one of a horizontal direction and a vertical direction, based on the split shape information, and split a non-square coding unit in a horizontal direction or a vertical direction.

According to an embodiment, when the image decoding apparatus 100 is capable of splitting a square coding unit in a horizontal direction and a vertical direction to obtain 4 square coding units, 4 split shapes may be indicated by the split shape information of the square coding unit. According to an embodiment, the split shape information may be represented as a 2-digit binary code, and a binary code may be assigned for each split shape. For example, when a coding unit is not split, the split shape information may be represented as (00)b, when a coding unit is split in a horizontal direction and a vertical direction, the split shape information may be represented as (01)b, when a coding unit is split in a horizontal direction, the split shape information may be represented as (10)b, and when a coding unit is split in a vertical direction, the split shape information may be represented as (11)b.

According to an embodiment, when the image decoding apparatus 100 splits a non-square coding unit in a horizontal direction or a vertical direction, a type of split shape indicated by the split shape information may be determined based on the split number of coding units. Referring to FIG. 18, the image decoding apparatus 100 may split the non-square coding unit into up to 3 coding units, according to an embodiment. The image decoding apparatus 100 may split a coding unit into two coding units and in this case, the split shape information may be represented as (10)b. The image decoding apparatus 100 may split a coding unit into three coding units and in this case, the split shape information may be represented as (11)b. The image decoding apparatus 100 may determine not to split a coding unit and in this case, the split shape information may be represented as (0)b. In otherwords, the image decoding apparatus 100 may use variable length coding (VLC) instead of fixed length coding (FLC) so as to use a binary code indicating the split shape information.

According to an embodiment, referring to FIG. 18, a binary code of the split shape information indicating that a coding unit is not split may be represented as (0)b. When a binary code of the split shape information indicating that a coding unit is not split is set to (00)b, binary codes of two bits of split shape information need to be all used despite that there is no split shape information set as (01)b. However, as shown in FIG. 18, when 3 types of split shapes are used for a non-square coding unit, the image decoding apparatus 100 is able to determine that a coding unit is not split even when using one-bit binary code (0)b as the split shape information, and thus a bitstream may be efficiently used. However, split shapes of a non-square coding unit indicated by the split shape information should not be interpreted limitedly to 3 shapes described with reference to FIG. 18, and should be interpreted as various shapes including the above-described embodiments.

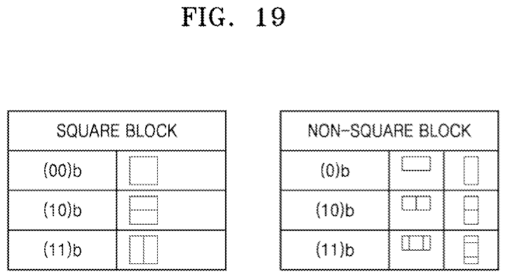

FIG. 19 illustrates other shapes of a coding unit that may be determined based on split shape information representable in a binary code, according to an embodiment.

Referring to FIG. 19, the image decoding apparatus 100 may split a square coding unit in a horizontal direction or a vertical direction, based on the split shape information, and may split a non-square coding unit in a horizontal direction or a vertical direction. In otherwords, the split shape information may indicate that a square coding unit is split in one direction. In this case, a binary code of split shape information indicating that a square coding unit is not split may be represented as (0)b. When a binary code of the split shape information indicating that a coding unit is not split is set to (00)b, binary codes of two bits of split shape information need to be all used despite that there is no split shape information set as (01)b. However, as shown in FIG. 19, when 3 types of split shapes are used for a square coding unit, the image decoding apparatus 100 is able to determine that a coding unit is not split even when using one-bit binary code (0)b as the split shape information, and thus a bitstream may be efficiently used. However, split shapes of a square coding unit indicated by the split shape information should not be interpreted limitedly to 3 shapes described with reference to FIG. 19, and should be interpreted as various shapes including the above-described embodiments.

According to an embodiment, block shape information or split shape information may be represented by using a binary code, and such information may be immediately generated as a bitstream. Alternatively, the block shape information or split shape information represented in a binary code may be used as a binary code input during context adaptive binary arithmetic coding (CABAC) without being immediately generated as a bitstream.

According to an embodiment, a process in which the image decoding apparatus 100 obtains syntax regarding block shape information or split shape information via CABAC will be described. A bitstream including a binary code of the syntax may be obtained via the bitstream obtainer 110. The image decoding apparatus 100 may detect a syntax element indicating block shape information or split shape information by inverse-binarizing a bin string included in the obtained bitstream. According to an embodiment, the image decoding apparatus 100 may obtain a set of binary bin strings corresponding to a syntax element to be decoded, and may decode each bin by using probability information, and may repeat such operations until a bin string including the decoded bins becomes the same as one of previously obtained bin strings. The image decoding apparatus 100 may determine the syntax element by performing inverse binarization on the bin string.

According to an embodiment, the image decoding apparatus 100 may determine the syntax for the bin string by performing a decoding process of adaptive binary arithmetic coding, and update a probability model for the bins obtained via the bitstream obtainer 110. Referring to FIG. 18, the bitstream obtainer 110 of the image decoding apparatus 100 may obtain the bitstream indicating the binary code indicating the split shape information, according to an embodiment. The image decoding apparatus 100 may determine the syntax for the split shape information by using the binary code having a size of 1 bit or 2 bits. The image decoding apparatus 100 may update a probability for each bit among the 2-bit binary code so as to determine the syntax for the split shape information. In other words, the image decoding apparatus 100 may update a probability of having a value of 0 or 1 when decoding a next bin, based on whether a value of a first bin among the 2-bit binary code is 0 or 1.

According to an embodiment, the image decoding apparatus 100 may update, while determining syntax, a probability for bins used while decoding bins of a bin string for the syntax, and may determine that certain bits of the bin string have the same probability without updating the probability.

Referring to FIG. 18, while determining syntax by using a bin string indicating split shape information for a non-square coding unit, the image decoding apparatus 100 may determine the syntax for the split shape information by using one bin having a value of 0 when the non-square coding unit is not split. In other words, when block shape information indicates that a current coding unit has a non-square shape, a first bin of a bin string for split shape mode information may be 0 when a non-square coding unit is not split and may be 1 when the non-square coding unit is split into 2 or 3 coding units. Accordingly, a probability that the first bin of the bin string of the split shape information for the non-square coding unit is 0 may be ⅓, and a probability that the first bin of the bin string of the split shape information for the non-square coding unit is 1 may be ⅔. As described above, because split shape mode information indicating that a non-square coding unit is not split may represent only a 1-bit bin string having a value of 0, the image decoding apparatus 100 may determine syntax for the split shape information by determining whether a second bin is 0 or 1 only when a first bin of the split shape information is 1. According to an embodiment, when the first bin of the split shape information is 1, the image decoding apparatus 100 may decode bins considering that probabilities of the second bin being 0 and 1 are the same.

According to an embodiment, the image decoding apparatus 100 may use various probabilities for each bin while determining the bins of the bin string for the split shape information. According to an embodiment, the image decoding apparatus 100 may differently determine the probabilities of the bins for the split shape information, based on a direction of a non-square block. According to an embodiment, the image decoding apparatus 100 may differently determine the probabilities of the bins for the split shape information, based on an area of a current coding unit or a length of a long side of the current coding unit. According to an embodiment, the image decoding apparatus 100 may differently determine the probabilities of the bins for the split shape information, based on at least one of the area of the current coding unit or the length of a long side of the current coding unit.

According to an embodiment, the image decoding apparatus 100 may determine that probabilities of bins for split shape information are the same with respect to coding units of a certain size or greater. For example, it may be determined that the probabilities of the bins for the split shape information are the same for coding units of a size of 64 samples or greater, based on the length of a long side of the coding unit.

According to an embodiment, the image decoding apparatus 100 may determine initial probabilities of the bins included in the bin string of the split shape information, based on a slice type (for example, an I-slice, a P-slice, or a B-slice).

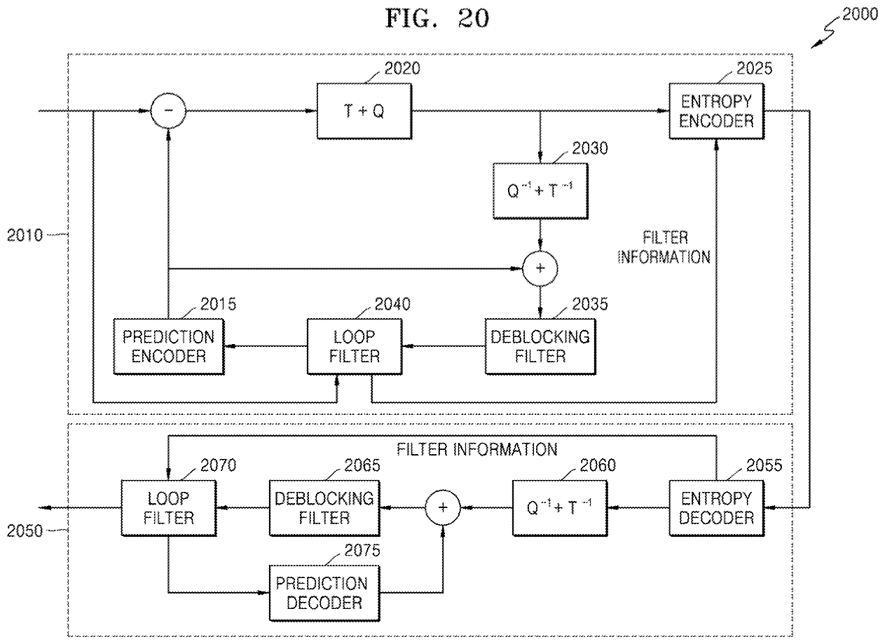

FIG. 20 is a block diagram of an image encoding and decoding system 2000 that performs loop filtering.

An encoding end 2010 of the image encoding and decoding system 2000 transmits an encoded bitstream of an image, and a decoding end 2050 thereof outputs a reconstructed image by receiving and decoding the bitstream. Here, the encoding end 2010 may have a similar configuration to the image encoding apparatus 200, which will be described later, and the decoding end 2050 may have a similar configuration to the image decoding apparatus 100.

At the encoding end 2010, a prediction encoder 2015 outputs a reference image via inter prediction and intra prediction, and a transformer and quantizer 2020 transforms and quantizes residual data between the reference image and a current input image to a quantized transform coefficient and outputs the quantized transform coefficient. An entropy encoder 2025 encodes the quantized transform coefficient, and outputs the encoded quantized transform coefficient as a bitstream. The quantized transform coefficient is reconstructed as data of a spatial domain via an inverse quantizer and inverse transformer 2030, and the data of the spatial domain is output as a reconstructed image via a deblocking filter 2035 and a loop filter 2040. The reconstructed image may be used as a reference image of a next input image via the prediction encoder 2015.

Encoded image data among the bitstream received by the decoding end 2050 is reconstructed as residual data of a spatial domain via an entropy decoder 2055 and an inverse quantizer and inverse transformer 2060. Image data of a spatial domain is configured when a reference image and residual data output from a prediction decoder 2075 are combined, and a deblocking filter 2065 and a loop filter 2070 may output a reconstructed image regarding a current original image by performing filtering on the image data of the spatial domain. The reconstructed image may be used by the prediction decoder 2075, as a reference image for a next original image.

The loop filter 2040 of the encoding end 2010 performs loop filtering by using filter information input according to a user input or system settings. The filter information used by the loop filter 2040 is output to the encoding end 2010 and transmitted to the decoding end 2050 together with the encoded image data. The loop filter 2070 of the decoding end 2050 may perform loop filtering based on the filter information input from the decoding end 2050.

The above-described various embodiments describe operations related to an image decoding method performed by the image decoding apparatus 100. Hereinafter, operations of the image encoding apparatus 200 performing an image encoding method corresponding to an inverse procedure of the image decoding method will be described via various embodiments.

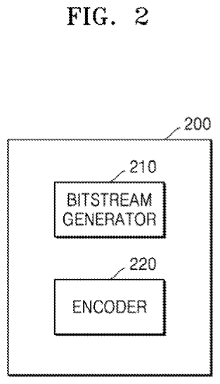

FIG. 2 is a block diagram of the image encoding apparatus 200 capable of encoding an image, based on at least one of block shape information and split shape information, according to an embodiment.

The image encoding apparatus 200 may include an encoder 220 and a bitstream generator 210. The encoder 220 may receive an input image and encode the input image. The encoder 220 may obtain at least one syntax element by encoding the input image. The syntax element may include at least one of a skip flag, a prediction mode, a motion vector difference, a motion vector prediction method (or index), a transform quantized coefficient, a coded block pattern, a coded block flag, an intra prediction mode, a direct flag, a merge flag, a delta QP, a reference index, a prediction direction, and a transform index. The encoder 220 may determine a context model, based on block shape information including at least one of a shape, direction, ratio of width and height, or size of a coding unit.

The bitstream generator 210 may generate a bitstream, based on the encoded input image. For example, the bitstream generator 210 may generate the bitstream by entropy-encoding the syntax element, based on the context model. Also, the image encoding apparatus 200 may transmit the bitstream to the image decoding apparatus 100.

According to an embodiment, the encoder 220 of the image encoding apparatus 200 may determine a shape of a coding unit. For example, the coding unit may have a square shape or a non-share shape, and information indicating such a shape may be included in block shape information.

According to an embodiment, the encoder 220 may determine in which shape a coding unit is to be split. The encoder 220 may determine a shape of at least one coding unit included in the coding unit, and the bitstream generator 210 may generate a bitstream including split shape information including information about such a shape of the coding unit.

According to an embodiment, the encoder 220 may determine whether a coding unit is to be split or not to be split. When the encoder 220 determines that only one coding unit is included in the coding unit or that the coding unit is not split, the bitstream generator 210 may generate a bitstream including split shape information indicating that the coding unit is not split. Also, the encoder 220 may split the coding unit into a plurality of coding units, and the bitstream generator 210 may generate the bitstream including split shape information indicating that the coding unit is split into the plurality of coding units.

According to an embodiment, information indicating the number of coding units into which the coding unit is to be split or a direction of splitting the coding unit may be included in the split shape information. For example, the split shape information may indicate that the coding unit is split in at least one of a vertical direction and a horizontal direction or is not split.

The image encoding apparatus 200 determines information about a split shape mode, based on a split shape mode of a coding unit. The image encoding apparatus 200 may determine a context model, based on at least one of a shape, direction, ratio of width and height, or size of the coding unit. Also, the image encoding apparatus 200 generates a bitstream including information about a split shape mode for splitting the coding unit based on the context model.

The image encoding apparatus 200 may obtain an array for mapping an index for the context model with at least one of the shape, direction, ratio of width and height, or size of the coding unit, in order to determine the context model. The image encoding apparatus 200 may obtain, from the array, the index for the context model, based on at least one of the shape, direction, ratio of width and height, or size of the coding unit. The image encoding apparatus 200 may determine the context model, based on the index for the context model.

The image encoding apparatus 200 may determine the context model, further based on block shape information including at least one of a shape, direction, ratio of width and height, or size of a neighboring coding unit adjacent to the coding unit, in order to determine the context model. The neighboring coding unit may include at least one of a coding unit located at bottom left, left, top left, top, right, top right, or bottom right of the coding unit.

Also, the image encoding apparatus 200 may compare the length of width of the top neighboring coding unit with the length of width of the coding unit to determine the context model. Also, the image encoding apparatus 200 may compare the lengths of heights of the left and right neighboring coding units with the length of height of the coding unit. Also, the image encoding apparatus 200 may determine the context model, based on comparison results.

Because operations of the image encoding apparatus 200 include similar contents to operations of the image decoding apparatus 100 described above with reference to FIGS. 3 through 20, detailed descriptions thereof will be omitted.

Hereinafter, an image decoding apparatus 2100 and an image encoding apparatus 2800 according to an embodiment will be described with reference to FIGS. 21 through 32.

FIG. 21 is a block diagram of the image decoding apparatus 2100 according to an embodiment.

Referring to FIG. 21, the image decoding apparatus 2100 according to an embodiment may include an obtainer 2110 and a prediction decoder 2130.

The image decoding apparatus 2100 according to an embodiment may include a central processor (not shown) for controlling the obtainer 2110 and the prediction decoder 2130. Alternatively, the obtainer 2110 and the prediction decoder 2130 may operate respectively by their own processors (not shown), and the processors may operate mutually organically such that the image decoding apparatus 2100 operates as a whole. Alternatively, the obtainer 2110 and the prediction decoder 2130 may be controlled under control of an external processor (not shown) of the image decoding apparatus 2100.

The image decoding apparatus 2100 may include at least one data storage (not shown) storing input and output data of the obtainer 2110 and prediction decoder 2130. The image decoding apparatus 2100 may include a memory controller (not shown) for controlling data input and output of the at least one data storage.

The image decoding apparatus 2100 may perform an image decoding operation including prediction by connectively operating with an internal video decoding processor or an external video decoding processor so as to reconstruct an image via image decoding. The internal video decoding processor of the image decoding apparatus 2100 according an embodiment may perform a basic image decoding operation as a separate processor, or as a central processing unit or a graphics processing unit including an image decoding processing module.

The image decoding apparatus 2100 may be included in the image decoding apparatus 100 described above. For example, the obtainer 2110 may be included in the bitstream obtainer 110 of the image decoding apparatus 100 of FIG. 1, and the prediction decoder 2130 may be included in the decoder 120 of the image decoding apparatus 100.

The image decoding apparatus 2100 may determine a motion vector for reconstructing a current block encoded via inter prediction.

A block may have a square shape, a rectangular shape, or any geometric shape. A block according to an embodiment is not limited to a data unit of a certain size, and may include a largest coding unit, a coding unit, a prediction unit, a transformation unit, and the like from among coding units based on a tree structure.

The obtainer 2110 obtains a bitstream including information for decoding an image. The bitstream may include information about at least one of a differential motion vector, a prediction motion vector, a prediction direction (either uni-direction prediction or bi-direction prediction), a reference image, and an MVR, according to a prediction mode of the current block.

The prediction decoder 2130 obtains the motion vector of the current block, based on the information included in the bitstream.

The prediction decoder 2130 may determine whether adaptive encoding has been applied to the differential motion vector of the current block. The adaptive encoding with respect to the differential motion vector may refer to an encoding method that is used to represent the differential motion vector with a small number of bits.

The prediction decoder 2130 may determine whether adaptive encoding has been applied to the differential motion vector, based on information indicating whether adaptive encoding has been applied, the information included in the bitstream. The information indicating whether adaptive encoding has been applied may include, for example, an index or flag, but embodiments are not limited thereto.

When adaptive encoding has been applied to the differential motion vector, the prediction decoder 2130 determines a coding factor value of the differential motion vector. The coding factor value (or a factor value) is used in adaptive encoding of the differential motion vector. Thus, according to an embodiment, the coding factor value may include an integer equal to or greater than 1.

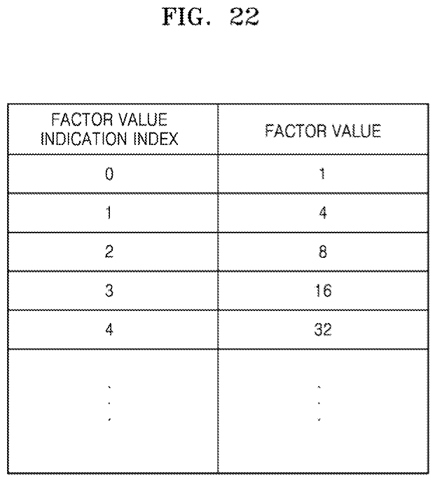

The prediction decoder 2130 may determine the coding factor value, based on indication information of a coding factor value included in the bitstream. The indication information of the coding factor value may include a flag or index. When the indication information of the coding factor value is an index, a coding factor value for each index is illustrate in FIG. 22. In FIG. 22, when a factor value indicating index is 0, the coding factor value may be determined to be 1, and, when the factor value indicating index is 1, the coding factor value may be determined to be 4.

According to an embodiment, the prediction decoder 2130 may determine the coding factor value, based on information related to at least one of a current block, a pre-decoded block, a current slice including the current block, a pre-decoded slice, a current picture including the current block, and a pre-decoded picture. In this case, information related to the coding factor value may not be included in the bitstream. For example, the prediction decoder 2130 may determine a coding factor value for the differential motion vector of the current block, based on at least one of the size of the current block, the prediction mode of the current block, the size of the pre-decoded block, the prediction mode of the pre-decoded block, the coding factor value of the pre-decoded block, the type of current slice, the type of pre-decoded slice, the type of current picture, and the type of pre-decoded picture.

As will be described later, the coding factor value may be determined based on a first MVR of a first component of the motion vector of the current block and a second MVR of a second component of the motion vector of the current block.

The prediction decoder 2130 may determine a first result value generated by applying adaptive encoding to the differential motion vector, based on the information included in the bitstream. As will be described later, the first result value may refer to a value obtained by the image encoding apparatus 2800 applying adaptive encoding to the differential motion vector of the current block. The first result value may be smaller than the differential motion vector of the current block. The prediction decoder 2130 may obtain, for example, information indicating the sign of the first result value and information indicating whether the absolute value of the first result value is greater than 0, from the bitstream, and may determine the first result value, based on the obtained information.

The prediction decoder 2130 may obtain the differential motion vector of the current block by applying the coding factor value to the first result value according to a certain operation. According to an embodiment, the certain operation may include a multiplication operation. Alternatively, according to an embodiment, the certain operation may include a linear operation including at least one of multiplication and addition. Alternatively, according to an embodiment, the certain operation may include an exponentiation operation.

For example, when the coding factor value is 4, the first result value is 2, and the certain operation is a multiplication operation, the prediction decoder 2130 may determine the differential motion vector of the current block to be 8(2*4). As another example, when the coding factor value is 4, the first result value is 2, and the certain operation is a exponentiation operation, the prediction decoder 2130 may determine the differential motion vector of the current block to be 16(2⁴).

According to an embodiment, the prediction decoder 2130 may determine a second result value generated by applying adaptive encoding to the differential motion vector, based on the information included in the bitstream. As will be described later, the second result value may refer to a value obtained by the image encoding apparatus 2800 applying adaptive encoding to the differential motion vector of the current block.

According to an embodiment, information of the number of bits for representing the second result value may be included in the bitstream. The obtainer 2110 may obtain bits corresponding to the second result value, according to the information of the number of bits, and the prediction decoder 2130 may determine the second result value, based on the obtained bits. The number of bits for representing the second result value may be less than that of bits for representing the coding factor value. For example, when the coding factor value is 8, four bits are needed to express the coding factor value, but less than four bits may be needed to express the second result value. This is because, when the certain operation is a division operation, the second result value corresponds to a value less than the coding factor value.

According to an embodiment, the information of the number of bits for representing the second result value may be previously determined in correspondence with the coding factor value, instead of not being included in the bitstream. For example, when the coding factor value is 8, the number of bits for representing the second result value may be previously determined to be 3, and, when the coding factor value is 7, the number of bits for representing the second result value may be previously determined to be 2.

The prediction decoder 2130 may determine the differential motion vector of the current block by applying the first result value, the second result value, and the coding factor value to the certain operation. For example, the certain operation may include an operation of multiplying the first result value by the coding factor value and adding the second result value to a result of the multiplication (i.e., coding factor value* first result value+second result value). In this case, the first result value may be referred to as a quotient of the differential motion vector, and the second result value may be referred to as a remainder of the differential motion vector. For example, the certain operation may include an operation of exponentiating the first result value according to the coding factor value and adding the second result value to a result of the exponentiation.

According to an embodiment, the prediction decoder 2130 may determine the coding factor value and the first result value (and the second result value) for each prediction direction of the current block and each component of the differential motion vector. In addition, the prediction decoder 2130 may determine the differential motion vector for each prediction direction of the current block and each component of the differential motion vector, by using the coding factor value and the first result value.

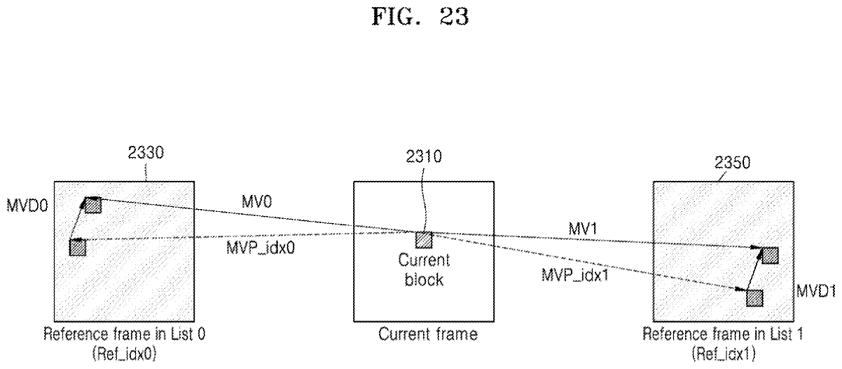

FIG. 23 is a view for explaining a motion vector, a prediction motion vector, and a differential motion vector when a current block is predicted bidiectionally.

A current block 2310 may be unidirectionally predicted using a reference picture 2330 included in list 0 or a reference picture 2350 included in list 1, or may be bidirectionally predicted using the two reference pictures 2330 and 2350 included in list 0 and list 1.

Referring to FIG. 23, the current block 2310 may be bidirectionally predicted through the reference picture 2330 included in list 0 and the reference picture 2350 included in list 1, and, in this case, a differential motion vector 0 corresponding to list 0 and a differential motion vector MVD1 corresponding to list 1 may be determined. Each of the differential motion vectors MVD0 and MVD1 may include a first component (e.g., a width direction component of a block) value and a second component (e.g., a height direction component of a block) value. In this case, the prediction decoder 2130 may determine a coding factor value and a first result value for a first component value MVD0_X of the differential motion vector MVD0 corresponding to list 0 to determine the first component value MVD0_X of the differential motion vector MVD0, and may determine a coding factor value and a first result value for a second component value MVD0_Y of the differential motion vector MVD0 corresponding to list 0 to determine the second component value MVD0_Y of the differential motion vector MVD0. The prediction decoder 2130 may determine a coding factor value and a first result value for a first component value MVD1_X of the differential motion vector MVD1 corresponding to list 1 to determine the first component value MVD1_X of the differential motion vector MVD1, and may determine a coding factor value and a first result value for a second component value MVD1_Y of the differential motion vector MVD1 corresponding to list 1 to determine the second component value MVD1_Y of the differential motion vector MVD1.

When the current block is unidirectionally predicted, the prediction decoder 2130 may determine a coding factor value and a first result value for a first component value of a differential motion vector corresponding to list 0 or list 1 to determine the first component value of the differential motion vector, and may determine a coding factor value and a first result value for a second component value of the differential motion vector corresponding to list 0 or list 1 to determine the second component value of the differential motion vector.

According to an embodiment, the prediction decoder 2130 may determine only one coding factor value, and may determine the differential motion vector by using a value derived by applying the one coding factor value to the certain operation for each prediction direction of the current block and/or each component thereof.

According to an embodiment, when adaptive encoding is not applied to the differential motion vector of the current block, the prediction decoder 2130 may obtain the differential motion vector, based on the information obtained from the bitstream, without performing the above-described process of determining the coding factor value, the above-described process of determining the first result value, and the above-described process of applying the coding factor value and the first result value to the certain operation. The information included in the bitstream may include, but is not limited to, information representing the sign of the differential motion vector and information representing whether the absolute value of the differential motion vector is greater than 0.

The prediction decoder 2130 may obtain the motion vector of the current block, based on the differential motion vector of the current block and the prediction motion vector of the current block. According to an embodiment, the prediction motion vector of the current block may be determined based on the motion vector of a neighboring block temporally and/or spatially adjacent to the current block.

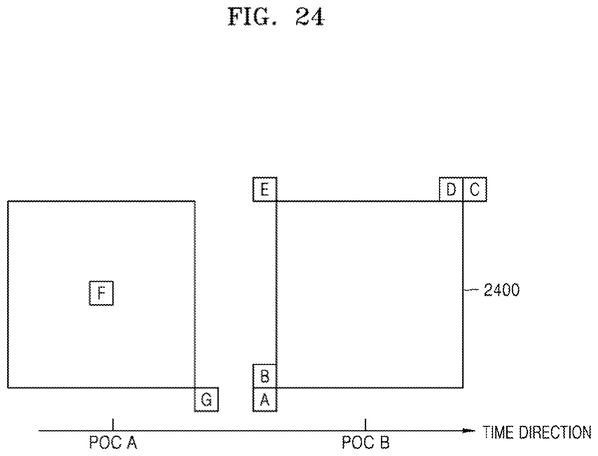

FIG. 24 is a diagram illustrating a temporal and/or spatial neighboring block temporally and/or spatially related to a current block 2400. Referring to FIG. 24, the temporal neighboring block may include at least one of a block F located at the same point as the current block 2400 in a reference image having a different picture order count (POC) from that of the current block 2400, and a block G spatially adjacent to the block F. The spatial neighboring block spatially related to the current block 2400 may include a lower left outer block A, a lower left block B, an upper right outer block C, an upper right block D, and an upper left outer block E. Locations of neighboring blocks shown in FIG. 24 are only examples, and locations of temporal neighboring blocks and spatial neighboring blocks may vary according to an embodiment.

The prediction decoder 2130 may determine a median value of the motion vector of at least one neighboring block to be the prediction motion vector of the current block, or may configure a prediction motion vector candidate by using the motion vectors of the neighboring blocks and then determine one prediction motion vector candidate to be the prediction motion vector of the current block, based on the information included in the bitstream.

According to an embodiment, when the motion vector of the current block is determined according to a certain MVR, the prediction decoder 2130 may determine the motion vector of a neighboring block pre-determined to correspond to the certain MVR to be the prediction motion vector.

The prediction decoder 2130 may adjust the prediction motion vector, based on the MVR of the current block, and may determine the motion vector of the current block by using the adjusted prediction motion vector and the differential motion vector.

The prediction decoder 2130 may store at least one candidate MVR that may be the MVR of the motion vector of each block. According to an embodiment, the at least one candidate MVR may include at least one of a ⅛ pixel unit MVR, a ¼ pixel unit MVR, a ½ pixel unit MVR, a 1 pixel unit MVR, a 2 pixel unit MVR, a 4 pixel unit MVR, and an 8 pixel unit MVR. However, the candidate MVR is not limited to the above example, and various values of pixel unit MVRs may be included in the candidate MVR.

The prediction decoder 2130 may refer to information representing the MVR included in the bitstream, in order to determine the MVR of the motion vector of the current block. According to an embodiment, the MVR of the motion vector of the current block may be separately determined according to the component of the motion vector of the current block. In detail, the first MVR of the first component (e.g., the width direction component of a block) of the motion vector of the current block and the second MVR of the second component (e.g., the width direction component of a block) of the motion vector of the current block may be independently determined.

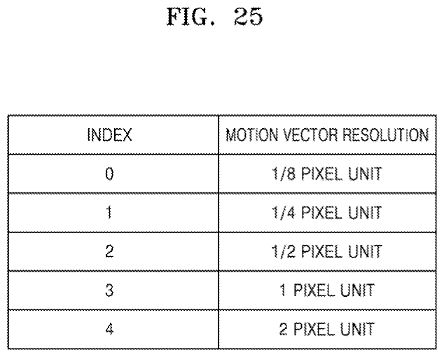

The bitstream may include information representing the first MVR and the second MVR, and the information may include, for example, an index or a flag. The prediction decoder 2130 may previously store information of correspondence between information representing an MVR and the MVR. Referring to FIG. 25, when the first MVR and the second MVR are expressed as indexes within the bitstream, an index 0 may represent a ⅛ pixel unit, and an index 1 may represent a ¼ pixel unit.

According to an embodiment, the obtainer 2110 may obtain information about the first MVR and information about the second MVR for each inter-predicted coding unit.

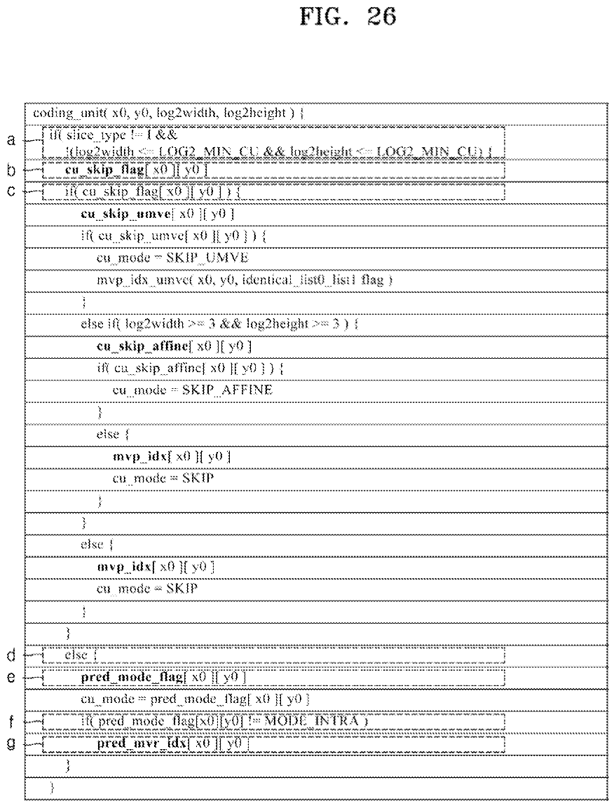

FIG. 26 illustrates a syntax that obtains the information about the first MVR and the information about the second MVR from the bitstream.

Referring to FIG. 26, when a slice including a current coding unit in a phrase a is not an I-slice, cu_skip_flag is extracted in a phrase b. cu_skip_flag represents whether to apply a skip mode to the current coding unit. When it is checked that the skip mode is applied in a phrase c, the current coding unit is processed according to the skip mode. When it is checked that the skip mode is not applied in a phrase d, pred_mode_flag is extracted in a phrase e. pred_mode_flag represents whether the current coding unit has been intra-predicted or inter-predicted. When the current coding unit has not been intra-predicted, namely, has been inter-predicted, in a phrase f, pred_mvr_idx is extracted in a phrase g. pred_mvr_idx is an index representing the MVR of the current coding unit, and an MVR corresponding to each index may be equal to Table 1 below.

TABLE 1

| | MVR Index | | | | |
|---|---|---|---|---|---|
| | 0 | 1 | 2 | 3 | 4 |
| Resolution (R) in pel | ¼ | ½ | 1 | 2 | 4 |

FIG. 26 shows that one index pred_mvr_idx is obtained in the phrase g, but the index pred_mvr_idx may be obtained for each component of the motion vector of the current coding unit.

According to an embodiment, the prediction decoder 2130 may directly determine the first MVR and the second MVR, based on information related to at least one of a current block, a pre-decoded block, a current slice including the current block, a pre-decoded slice, a current picture including the current block, and a pre-decoded picture. In this case, information representing the first MVR and information representing the second MVR may not be included in the bitstream.

For example, the prediction decoder 2130 may determine the first MVR and the second MVR in consideration of the width and height of the current block. When the width of the current block is larger than the height thereof, the prediction decoder 2130 may determine the first MVR to be greater than the second MVR. On the other hand, when the height of the current block is greater than the width thereof, the prediction decoder 2130 may determine the second MVR to be greater than the first MVR. Alternatively, when the width of the current block is larger than the height thereof, the prediction decoder 2130 may determine the first MVR to be smaller than the second MVR. On the other hand, when the height of the current block is greater than the width thereof, the prediction decoder 2130 may determine the second MVR to be smaller than the first MVR.

According to an embodiment, the prediction decoder 2130 may determine the first MVR and the second MVR according to the size of the current block. For example, when the size of the current block is equal to or greater than a certain size, the prediction decoder 2130 may determine the first MVR and the second MVR to be equal to or greater than a 1 pixel unit, and, when the size of the current block is less than the certain size, the prediction decoder 2130 may determine the first MVR and the second MVR to be less than a 1 pixel unit.

According to an embodiment, the prediction decoder 2130 may determine the first MVR and the second MVR of the current block, based on the first MVR and the second MVR of a pre-decoded block. For example, when the first MVR of the pre-decoded block is a ¼ pixel unit, the prediction decoder 2130 may determine the first MVR of the current block to be also a ¼ pixel unit, and, when the second MVR of the pre-decoded block is a 1 pixel unit, the prediction decoder 2130 may determine the second MVR of the current block to be also a 1 pixel unit.

One MVR being greater than another MVR may mean that the pixel unit of the one MVR is greater than that of the other MVR. For example, the MVR of a 1 pixel unit is greater than the MVR of a ½ pixel unit, and the MVR of the ½ pixel unit is greater than the MVR of a ¼ pixel unit. In fact, more precise prediction is possible when a motion vector is determined using the MVR of the ¼ pixel unit, than when the motion vector is determined using the MVR of the 1 pixel unit. However, for convenience of explanation, a size difference of each MVR based on the size of a pixel unit is described here.

The prediction decoder 2130 may determine a coding factor value for adaptive encoding of the differential motion vector, based on the first MVR and the second MVR. For example, the prediction decoder 2130 may determine an average value of the first MVR and the second MVR to be the coding factor value. Alternatively, the prediction decoder 2130 may determine the coding factor value by applying the first MVR and the second MVR to a certain operation.

According to an embodiment, the prediction decoder 2130 may adjust the prediction motion vector of the current block, based on a difference between the first MVR and the second MVR of the current block and a minimum MVR from among the at least one candidate MVR. The prediction decoder 2130 may determine the motion vector of the current block by using the prediction motion vector selectively adjusted according to a result of the comparison between the MVR sizes and the differential motion vector.

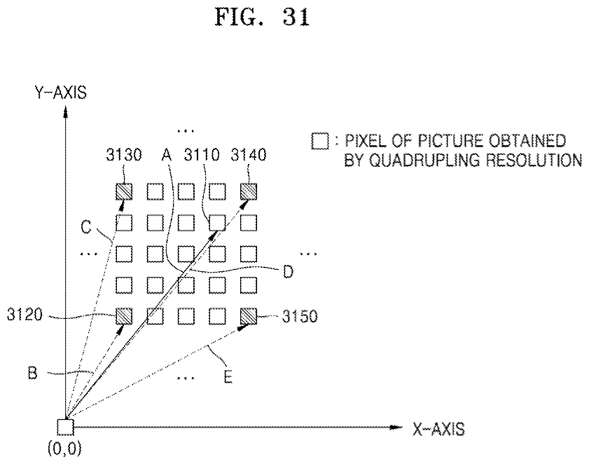

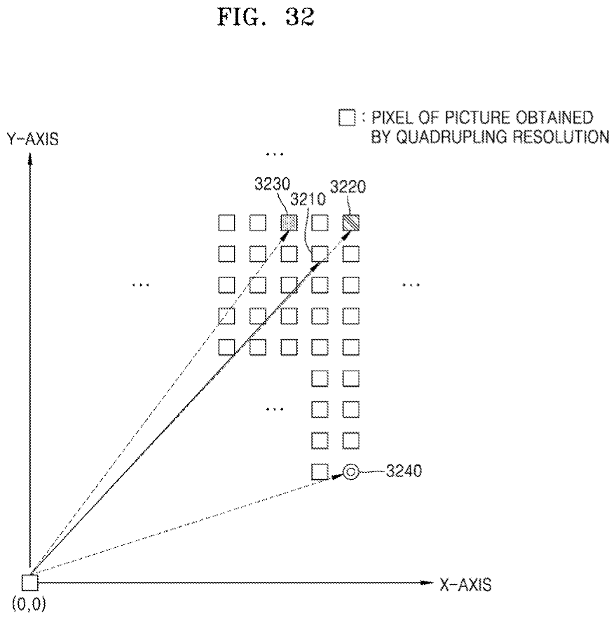

A process of adjusting the motion vector of a neighboring block will be described later with reference to FIGS. 31 and 32.

The prediction decoder 2130 may search for a prediction block from a reference image by using the motion vector of the current block, and may reconstruct the current block by adding dequantized and inversely-transformed residual data to the found prediction block.

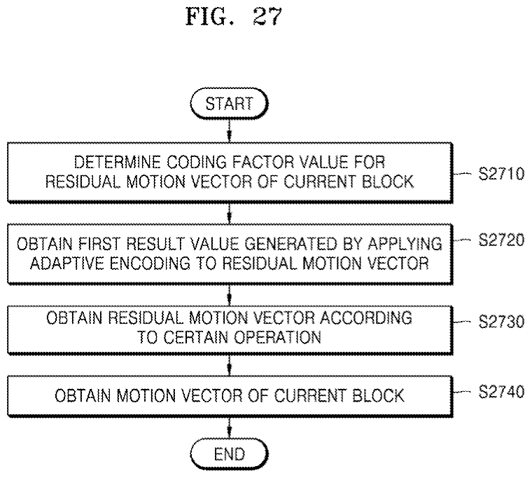

FIG. 27 is a flowchart of a method of decoding motion information, according to an embodiment.

In operation S2710, when the image decoding apparatus 2100 determines that adaptive encoding has been applied to the differential motion vector of the current block, the image decoding apparatus 2100 determines the coding factor value.

As described above, the image decoding apparatus 2100 may determine the coding factor value, based on the bitstream, or may determine the coding factor value, based on information related to at least one of a current block, a pre-decoded block, a current slice including the current block, a pre-decoded slice, a current picture including the current block, and a pre-decoded picture.

In operation S2720, the image decoding apparatus 2100 obtains a first result value by applying adaptive encoding to the differential motion vector of the current block.

The image decoding apparatus 2100 may obtain the first result value, based on information included in the bitstream.

According to an embodiment, the image decoding apparatus 2100 may obtain a second result value by applying adaptive encoding to the differential motion vector of the current block. The image decoding apparatus 2100 may obtain the second result value, based on information included in the bitstream.

In operation S2730, the image decoding apparatus 2100 obtains the differential motion vector of the current block by applying the coding factor value to the first result value according to a certain operation. When the second result value is obtained, the image decoding apparatus 2100 may obtain the differential motion vector of the current block by applying the coding factor value to the first result value and the second result value according to a certain operation.

The certain operation may include multiplication, exponentiation, and the like. The certain operation may also include a linear operation including at least one of multiplication and addition.

In operation S2740, the image decoding apparatus 2100 obtains a motion vector of the current block by using the differential motion vector of the current block and the prediction motion vector of the current block. The image decoding apparatus 2100 may obtain the motion vector of the current block in addition to the differential motion vector of the current block and the prediction motion vector of the current block.

The image decoding apparatus 2100 may adjust the prediction motion vector of the current block, based on the MVR of the motion vector of the current block, and, in this case, may obtain the motion vector of the current block by using the adjusted prediction motion vector and the differential motion vector.

The image decoding apparatus 2100 may determine the MVR of the motion vector of the current block for each component of the motion vector. For example, the image decoding apparatus 2100 may determine the first MVR of the first component of the motion vector of the current block and the second MVR of the second component of the motion vector of the current block.

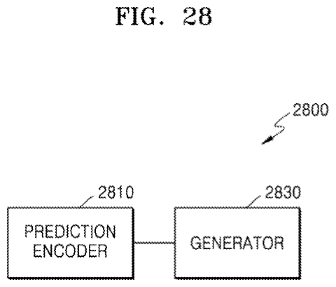

FIG. 28 is a block diagram of the image encoding apparatus 2800 according to an embodiment.

Referring to FIG. 28, the image encoding apparatus 2800 according to an embodiment may include a prediction encoder 2810 and a generator 2830.

The image encoding apparatus 2800 according to an embodiment may include a central processor (not shown) for controlling the prediction encoder 2810 and the generator 2830. Alternatively, the prediction encoder 2810 and the generator 2830 may operate respectively by their own processors (not shown), and the processors may operate mutually organically such that the image encoding apparatus 2800 operates as a whole. Alternatively, the prediction encoder 2810 and the generator 2830 may be controlled under control of an external processor (not shown) of the image encoding apparatus 2800.

The image encoding apparatus 2800 may include at least one data storage (not shown) where input and output data of the prediction encoder 2810 and the generator 2830 is stored. The image encoding apparatus 2800 may include a memory controller (not shown) for controlling data input and output of the data storage.

The image encoding apparatus 2800 may perform an image encoding operation including prediction by connectively operating with an internal video encoding processor or an external video encoding processor so as to encode an image. The internal video encoding processor of the image encoding apparatus 2800 according an embodiment may perform a basic image encoding operation, as a separate processor, or as a central processing unit or a graphics processing unit including an image encoding processing module.

The image encoding apparatus 2800 may be included in the image encoding apparatus 200 described above. For example, the generator 2830 may be included in the bitstream generator 210 of the image encoding apparatus 200 of FIG. 2, and the prediction encoder 2810 may be included in the encoder 220 of the image encoding apparatus 200.

The image encoding apparatus 2800 may determine the motion vector of the current block through inter prediction with respect to the current block. The image encoding apparatus 2800 may encode the differential motion vector determined using the motion vector of the current block and the prediction motion vector of the current block.

According to an embodiment, the prediction motion vector of the current block may be determined based on the motion vector of a neighboring block temporally and/or spatially adjacent to the current block. The neighboring block temporally and/or spatially adjacent to the current block is illustrated in FIG. 24.

The prediction encoder 2810 may determine a median value of the motion vector of at least one neighboring block to be the prediction motion vector of the current block, or may configure prediction motion vector candidates by using the motion vectors of the neighboring blocks and then determine one from the prediction motion vector candidates to be the prediction motion vector of the current block.

According to an embodiment, when the motion vector of the current block is determined according to a certain MVR, the prediction encoder 2810 may adjust the prediction motion vector and may determine the differential motion vector of the current block by using the adjusted prediction motion vector and the motion vector of the current block. As described above, the prediction encoder 2810 may determine the MVR of the motion vector of the current block for each component of the motion vector. In other words, the prediction encoder 2810 may determine the first MVR of the first component of the motion vector of the current block and the second MVR of the second component of the motion vector of the current block. The first MVR and the second MVR may be the same as each other or may be different from each other.

The prediction encoder 2810 may determine whether to apply adaptive encoding to the differential motion vector of the current block. For example, the prediction encoder 2810 may determine whether to apply adaptive encoding, by comparing a bitrate of a case where adaptive encoding is applied to the differential motion vector of the current block with a bitrate of a case where adaptive encoding is not applied to the differential motion vector of the current block.

According to an embodiment, the prediction encoder 2810 may determine whether to apply adaptive encoding, in consideration of information related to at least one of a current block, a pre-encoded block, a current slice including the current block, a pre-encoded slice, a current picture including the current block, and a pre-encoded picture.

When it is determined that adaptive encoding is applied to the differential motion vector, the prediction encoder 2810 determines a coding factor value for adaptive encoding. The coding factor value may include an integer that is equal to or greater than 1.

The prediction encoder 2810 may determine a factor value candidate causing a smallest overall number of bits of a first result value and a second result value of the differential motion vector and factor value indication information representing a factor value candidate, the first result, the second result, and the factor value indication information being derived by applying each of a plurality of factor value candidates to the differential motion vector of the current block, to be the coding factor value of the differential motion vector of the current block. The plurality of factor value candidates may include 1, 4, 8, 16, 32, and the like.

The first result value and the second result value refer to values derived by applying a coding factor value to the differential motion vector according to a certain operation. The first result value and the second result value may be smaller than the differential motion vector of the current block. The certain operation may include a division operation or a log operation. Alternatively, the certain operation may include a linear operation including at least one of division, addition, and subtraction.

For example, when the certain operation is division, the differential motion vector is 32, and the coding factor value is 2, the first result value may be 16(32/2). As another example, when the certain operation is division, the differential motion vector is 33, and the coding factor value is 2, the first result value may be 16 and the second result value may be 1. The first result value may be referred to as a quotient, and the second result value may be referred to as a remainder.

For example, when the certain operation is a log operation, the differential motion vector is 32, and the coding factor value is 2, the first result value may be 5(log₂ 32). As another example, when the certain operation is a log operation, the differential motion vector is 33, and the coding factor value is 2, the first result value may be 5(log₂(33−1)) and the second result value may be 1(33−32). In this case, the image decoding apparatus 2100 may derive 32 by using a coding factor value of 2 and a first result value of 5 and add a second result value of 1 to 32 to determine a differential motion vector of 33.

The prediction encoder 2810 may determine one factor value candidate to be the coding factor value of the current block, in consideration of the number of bits necessary for representing the first result value, the second result value, and indication information of the above-described coding factor value, wherein the first result value, the second result value, and the indication information of the above-described coding factor value are derived by applying each of a plurality of factor value candidates to the differential motion vector of the current block according to a certain operation.

According to an embodiment, the prediction encoder 2810 may determine the coding factor value of the current block in consideration of information related to at least one of a current block, a pre-encoded block, a current slice including the current block, a pre-encoded slice, a current picture including the current block, and a pre-encoded picture. In this case, the prediction encoder 2810 may determine the coding factor value according to the same method as a method, performed by the above-described prediction decoder 2130, of directly determining the coding factor value of the current block.

According to an embodiment, the prediction decoder 2810 may determine the coding factor value, based on the first MVR and the second MVR of the motion vector of the current block.

According to an embodiment, the prediction encoder 2810 may determine the coding factor value and the first result value (and the second result value) for each prediction direction of the current block and each component of the differential motion vector.

According to an embodiment, when the prediction encoder 2810 determines that adaptive encoding is not applied to the differential motion vector of the current block, the prediction encoder 2810 may not perform the above-described process of determining the coding factor value and the above-described process of determining the first result value. Instead, the prediction encoder 2810 may generate information about the differential motion vector, for example, information representing the sign of the differential motion vector and information representing whether the absolute value of the differential motion vector is greater than 0 and so on, and may include the generated information in the bitstream through the generator 2830 which will be described later.

When determining the motion vector of the current block, the prediction encoder 2810 may determine the first MVR of the first component of the motion vector and the second MVR of the first component of the motion vector, and may determine the first component value and the second component value of the motion vector according to the determined first MVR and the determined second MVR.

The prediction encoder 2810 may store at least one candidate MVR that may be the MVR of the motion vector of each block. According to an embodiment, the at least one candidate MVR may include at least one of a ⅛ pixel unit MVR, a ¼ pixel unit MVR, a ½ pixel unit MVR, a 1 pixel unit MVR, a 2 pixel unit MVR, a 4 pixel unit MVR, and an 8 pixel unit MVR. However, the candidate MVR is not limited to the above example, and various values of pixel unit MVRs may be included in the candidate MVR.

The prediction encoder 2810 may determine the first MVR and the second MVR by comparing a performance difference between cases where the motion vector of the current block is encoded using at least one candidate MVR. The prediction encoder 2810 may determine the first MVR and the second MVR from among the at least one candidate MVR, based on costs. A rate-distortion cost may be used to calculate the costs.

According to an embodiment, the prediction encoder 2810 may determine the first MVR and the second MVR, based on information related to at least one of a current block, a pre-encoded block, a current slice including the current block, a pre-encoded slice, a current picture including the current block, and a pre-encoded picture.

For example, the prediction encoder 2810 may determine the first MVR and the second MVR in consideration of the width and height of the current block. When the width of the current block is larger than the height thereof, the prediction encoder 2810 may determine the first MVR to be greater than the second MVR. On the other hand, when the height of the current block is greater than the width thereof, the prediction encoder 2810 may determine the second MVR to be greater than the first MVR. Alternatively, when the width of the current block is larger than the height thereof, the prediction encoder 2810 may determine the first MVR to be smaller than the second MVR. On the other hand, when the height of the current block is greater than the width thereof, the prediction encoder 2810 may determine the second MVR to be smaller than the first MVR.

According to an embodiment, the prediction encoder 2810 may determine the first MVR and the second MVR according to the size of the current block. For example, when the size of the current block is equal to or greater than a certain size, the prediction encoder 2810 may determine the first MVR and the second MVR to be equal to or greater than a 1 pixel unit, and, when the size of the current block is less than the certain size, the prediction encoder 2810 may determine the first MVR and the second MVR to be less than a 1 pixel unit.

According to an embodiment, the prediction encoder 2810 may determine the first MVR and the second MVR of the current block, based on the first MVR and the second MVR of a pre-encoded block. For example, when the first MVR of the pre-encoded block is a ¼ pixel unit, the prediction encoder 2810 may determine the first MVR of the current block to be also a ¼ pixel unit, and, when the second MVR of the pre-encoded block is a 1 pixel unit, the prediction encoder 2810 may determine the second MVR of the current block to be also a 1 pixel unit.

According to an embodiment, the prediction encoder 2810 may adjust the prediction motion vector of the current block, based on a difference between the first MVR and the second MVR of the current block and a minimum MVR from among the at least one candidate MVR. The prediction encoder 2810 may obtain the differential motion vector of the current block by using the prediction motion vector selectively adjusted according to a result of the comparison between the MVR sizes and the motion vector.

A process of adjusting the prediction motion vector will be described later with reference to FIGS. 31 and 32.

The generator 2830 generates a bitstream including information generated as a result of encoding an image. The bitstream may include the prediction mode of the current block, information representing whether adaptive encoding has been applied to the differential motion vector, and information about at least one of the coding factor value, the first result value, the second result value, the first MVR, the second MVR, and the differential motion vector.

According to an embodiment, the generator 2830 may generate the bitstream by using an Exponential-Golomb Coding method for the first result value and using a Fixed Coding method for the second result value.

According to an embodiment, the generator 2830 may include information of the number of bits for representing the second result value, in the bitstream. The number of bits for representing the second result value may be less than that of bits for representing the coding factor value. For example, when the coding factor value is 8, four bits are needed to express the coding factor value, and, in this case, less than four bits may be needed to express the second result value. This is because, when the certain operation is a division operation, the second result value corresponds to a value less than the coding factor value. The generator 2830 may include information indicating that, when the second result value corresponds to 6, the number of bits for representing the second result value is 3, in the bitstream.

According to an embodiment, when information of the number of bits for representing the second result value is previously determined in correspondence with the coding factor value, the generator 2830 may not include the information of the number of bits for representing the second result value, in the bitstream. When the coding factor value is determined, the image decoding apparatus 2100 may ascertain the information of the number of bits for representing the second result value, and thus may obtain a certain number of bits from the bitstream and may determine the second result value, based on the obtained bits.

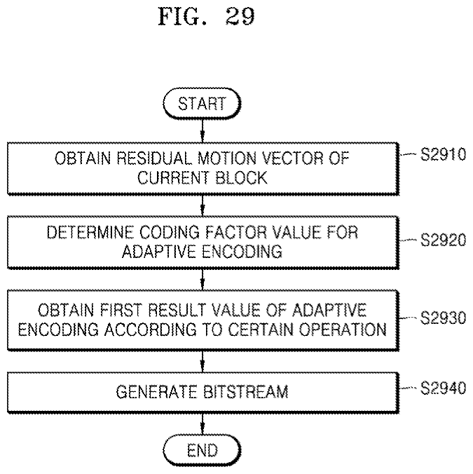

FIG. 29 is a flowchart of a method of encoding motion information, according to an embodiment.

In operation S2910, the image encoding apparatus 2800 obtains the differential motion vector of the current block. The image encoding apparatus 2800 may obtain the differential motion vector by using the motion vector of the current block and the prediction motion vector of the current block.

According to an embodiment, the image encoding apparatus 2800 may determine the first MVR of the first component of the motion vector of the current block and the second MVR of the first component of the motion vector of the current block, and may determine the first component value and the second component value of the motion vector of the current block according to the determined first MVR and the determined second MVR.

According to an embodiment, the image encoding apparatus 2800 may determine the prediction motion vector of the current block, based on the motion vector of at least one neighboring block. The image encoding apparatus 2800 may adjust the prediction motion vector, based on a result of a comparison between the first and second MVRs and the minimum MVR from among at least one candidate MVR.

In operation S2920, when the image encoding apparatus 2800 determines that adaptive encoding is to be applied to the differential motion vector of the current block, the image encoding apparatus 2800 determines the coding factor value.

As described above, the image encoding apparatus 2800 may determine one factor value candidate from several factor value candidates to be the coding factor value of the current block. According to an embodiment, the image encoding apparatus 2800 may determine the coding factor value, based on information related to at least one of a current block, a pre-encoded block, a current slice including the current block, a pre-encoded slice, a current picture including the current block, and a pre-encoded picture.

According to an embodiment, the image encoding apparatus 2800 may determine the coding factor value, based on the first MVR and the second MVR.

In operation S2930, the image encoding apparatus 2800 may obtain the first result value by applying the coding factor value to the differential motion vector of the current block according to a certain operation. The image encoding apparatus 2800 may further obtain the second result value by applying the coding factor value to the differential motion vector of the current block according to a certain operation.

In operation S2940, the image encoding apparatus 2800 generates the bitstream, based on the first result value. When the second result value is also obtained, the image encoding apparatus 2800 may generate the bitstream, based on the first result value and the second result value.

According to an embodiment, the bitstream may include the prediction mode of the current block, information representing whether adaptive encoding has been applied to the differential motion vector, and information about at least one of the coding factor value, the first result value, the second result value, the first MVR, the second MVR, and the differential motion vector.

According to an embodiment, when adaptive encoding is not applied to the differential motion vector of the current block, the bitstream may not include information about the coding factor value, the first result value, and the second result value.

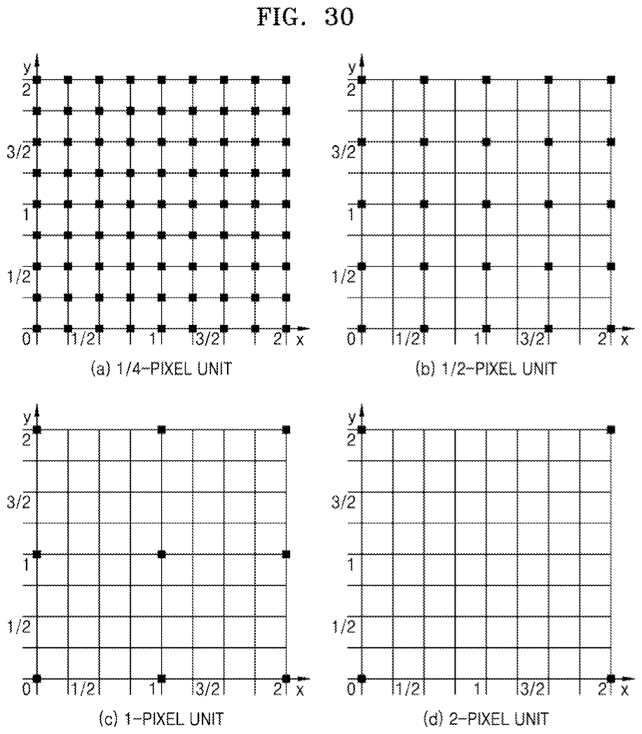

FIG. 30 illustrates positions of pixels that may be indicated by motion vectors according to a ¼ pixel unit MVR, a ½ pixel unit MVR, a 1 pixel unit MVR, and a 2 pixel unit MVR.

(a), (b), (c), and (d) of FIG. 30 respectively illustrate coordinates (marked by black squares) of pixels that may be indicated by motion vectors of the ¼ pixel unit MVR, the ½ pixel unit MVR, the 1 pixel unit MVR, and the 2 pixel unit MVR based on coordinates (0, 0).

When a minimum MVR is the ¼ pixel unit MVR, the coordinates of the pixel that may be indicated by the motion vector of the ¼ pixel unit MVR become (a/4, b/4) (where a and b are integers), the coordinates of the pixel that may be indicated by the motion vector of the ½ pixel unit MVR become (2c/4, 2d/4) (where c and d are integers), the coordinates of the pixel that may be indicated by the motion vector of the 1 pixel unit MVR become (4e/4, 4f/4) (where e and f are integers), and the coordinates of the pixel that may be indicated by the motion vector of the 2 pixel unit MVR become (8g/4, 8h/4) (where g and h are integers). That is, when a minimum MVR has a 2^{m} (m is an integer) pixel unit, coordinates of a pixel that may be indicated by a 2^{m} (n is an integer) pixel unit MVR become (2^{n-m*}i/2^{-m}, 2^{n-m}j/2^{-m}) (i and j are integers). Although a motion vector is determined according to a specific MVR, the motion vector is represented by coordinates in an image interpolated according to a ¼ pixel unit.

According to an embodiment, because a motion vector is interpolated in an image interpolated according to a minimum MVR, in order to represent the motion vector by using an integer, the motion vector of an integer unit may be represented by multiplying the motion vector by a reciprocal of a pixel unit value of the minimum MVR, for example, 2^{-m} when the minimum MVR has a 2^{m} (m is an integer) pixel unit. The motion vector of the integer unit multiplied by 2^{-m} may be used in the image decoding apparatus 2100 and the image encoding apparatus 2800.

When the motion vector of the ½ pixel unit MVR starting from the coordinates (0, 0) indicates coordinates (2/4, 6/4) and the minimum MVR has a ¼ pixel unit, the image encoding apparatus 2800 may determine (2, 6), which is obtained by multiplying the motion vector by an integer 4, as a motion vector.

When a size of an MVR is less than a 1 pixel unit, in order to perform motion prediction in a subpixel unit, the image encoding apparatus 2800 according to an embodiment may search for a block similar to a current block in a reference image based on the subpixel unit according to a motion vector determined in an integer pixel unit.

For example, when an MVR of a current block is the ¼ pixel unit MVR, the image encoding apparatus 2800 may determine a motion vector in an integer pixel unit, may interpolate a reference image to generate subpixels of ½ pixel unit, and then may search for a most similar prediction bock in a (−1 ˜1, −1 ˜1) range based on the motion vector determined in the integer pixel unit. Next, the image encoding apparatus 2800 may interpolate the reference image to generate subpixels of ¼ pixel unit again, and then may search for a most similar prediction block in the (−1 ˜1, −1 ˜1) range based on a motion vector determined in a ½ pixel unit, thereby determining a motion vector of the final ¼ pixel unit MVR.

For example, when a motion vector of an integer pixel unit is (−4, −3) based on the coordinates (0, 0), a motion vector in the ½ pixel unit MVR becomes (−8, −6) (=(−4*2, −3*2)); and when the motion vector moves by (0, −1), the motion vector of the ½ pixel unit MVR is finally determined to be (−8, −7) (=(−8, −6−1)). When a motion vector in the ¼ pixel unit MVR is changed to (−16, −14) (=(−8*2, −7*2)); and when the motion vector moves by (−1, 0) again, a final motion vector of the ¼ pixel unit MVR may be determined to be (−17, −14) (=(−16−1, −14)).

As described above, when the MVR of the motion vector of the current block is determined for each component of the motion vector, the image encoding apparatus 2800 may determine the first component value of the motion vector of the current block according to the first MVR and may determine the second component value of the motion vector of the current block according to the second MVR.

When the MVR of the current block is higher than the 1 pixel unit MVR, in order to perform motion prediction in a large pixel unit, the image encoding apparatus 2800 according to an embodiment may search for a block similar to the current block in a reference picture based on a pixel unit larger than a 1 pixel unit according to a motion vector determined in an integer pixel unit. Pixels located in pixel units (e.g., a 2 pixel unit, a 3 pixel unit, and a 4 pixel unit) larger than the 1 pixel unit may be referred to as super pixels.

A prediction motion vector adjusting method selectively performed by the image encoding apparatus 2800 and the image decoding apparatus 2100 according to an embodiment will now be described with reference to FIGS. 31 and 32.

When an MVR of the current block is higher than a minimum MVR from among selectable candidate MVRs, the image encoding apparatus 2800 and the image decoding apparatus 2100 may adjust a prediction motion vector of the current block.

In order to adjust the prediction motion vector represented by coordinates in an image interpolated according to the minimum MVR to the MVR of the current block, the image encoding apparatus 2800 and the image decoding apparatus 2100 may adjust the prediction motion vector to indicate neighboring pixels instead of a pixel indicated by the prediction motion vector.

For example, when the minimum MVR is a ¼ pixel unit and the MVR of the current block is a 1 pixel unit, in order to adjust a prediction motion vector A indicating a pixel 3110 of coordinates (19, 27) based on coordinates (0, 0) in FIG. 31 to a 1 pixel unit MVR that is the MVR of the current block, the coordinates (19, 27) of the pixel 3110 indicated by the prediction motion vector A may be divided by an integer 4 (that is, may be downscaled), and coordinates (19/4, 27/4) obtained as a division result may not indicate an integer pixel unit.

The image encoding apparatus 2800 and the image decoding apparatus 2100 may adjust the downscaled prediction motion vector to indicate an integer pixel unit. For example, coordinates of neighboring integer pixels around the coordinates (19/4, 27/4) are (16/4, 28/4), (16/4, 24/4), (20/4, 28/4), and (20/4, 24/4). In this case, the image encoding apparatus 2800 and the image decoding apparatus 2100 may adjust the downscaled prediction motion vector A to indicate the coordinates (20/4, 28/4) located at the right-top instead of the coordinates (19/4, 27/4), and then may multiply an integer 4 (that is, upscale) again so that a finally adjusted prediction motion vector D indicates a pixel 3140 corresponding to coordinates (20, 28).

Referring to FIG. 31, the prediction motion vector A before adjustment may indicate the pixel 3110, and the finally adjusted prediction motion vector D may indicate the pixel 3140 of an integer unit located at the right-top of the pixel 3110.

When adjusting a prediction motion vector according to an MVR of a current block, the image encoding apparatus 2800 and the image decoding apparatus 2100 according to an embodiment may cause the adjusted prediction motion vector to indicate a pixel located at the right-top of a pixel indicated by the prediction motion vector before adjustment. The image encoding apparatus 2800 and the image decoding apparatus 2100 according to another embodiment may cause the adjusted prediction motion vector to indicate a pixel located at the left-top, a pixel located at the left-bottom, or a pixel located at the right-bottom of the pixel indicated by the prediction motion vector before adjustment.

According to an embodiment, when any one of an x-coordinate value and a y-coordinate value indicated by the downscaled prediction motion vector indicates an integer pixel, the image encoding apparatus 2800 and the image decoding apparatus 2100 may increase or decrease only the coordinate value not indicating the integer pixel to indicate an integer pixel. That is, when the x-coordinate value indicated by the downscaled prediction motion vector does not indicate an integer pixel, the image encoding apparatus 2800 and the image decoding apparatus 2100 may cause the x-coordinate value of the adjusted prediction motion vector to indicate an integer pixel located at the left or the right of the pixel indicated by the x-coordinate value of the prediction motion vector before adjustment. Alternatively, when the y-coordinate value indicated by the downscaled prediction motion vector does not indicate an integer pixel, the image encoding apparatus 2800 and the image decoding apparatus 2100 may cause the y-coordinate value of the adjusted prediction motion vector to indicate an integer pixel located at the top or the bottom of the pixel indicated by the y-coordinate value of the prediction motion vector before adjustment.

When adjusting the prediction motion vector, the image encoding apparatus 2800 and the image decoding apparatus 2100 may differently select a point indicated by the adjusted prediction motion vector according to the MVR of the current block.

For example, referring to FIG. 32, when the MVR of the current block is a ½ pixel unit MVR, the image encoding apparatus 2800 and the image decoding apparatus 2100 may cause the adjusted prediction motion vector to indicate a pixel 3230 at the left-top of a pixel 3210 indicated by the prediction motion vector before adjustment; when the MVR of the current block is a 1 pixel unit MVR, the image encoding apparatus 2800 and the image decoding apparatus 2100 may cause the adjusted prediction motion vector to indicate a pixel 3220 at the right-top of the pixel 3210 indicated by the prediction motion vector before adjustment; and when the MVR of the current block is a 2 pixel unit MVR, the image encoding apparatus 2800 and the image decoding apparatus 2100 may cause the adjusted prediction motion vector to indicate a pixel 3240 at the right-bottom of the pixel 3210 indicated by the prediction motion vector before adjustment.

The image encoding apparatus 2800 and the image decoding apparatus 2100 may determine which pixel is to be indicated by the adjusted prediction motion vector, based on at least one from among the MVR of the current block, the prediction motion vector, information of a neighboring block, encoding information, and an arbitrary pattern.

When the prediction motion vector is adjusted in consideration of the MVR of the current block and the minimum MVR, the image encoding apparatus 2800 and the image decoding apparatus 2100 may adjust the prediction motion vector according to Equation 1.

pMV′=((pMV>>k)+offset)≥≥k [Equation 1]

In Equation 1, when pMV′ denotes the adjusted prediction motion vector, and k that is a value determined according to a difference between the MVR of the current block and the minimum MVR may be m-n when the MVR of the current block is a 2^{m} pixel unit (m is an integer), the minimum MVR is a 2ⁿ pixel unit (n is an integer), and m>n.

According to an embodiment, k may be an index of an MVR, and when candidate MVRs include a ¼ pixel unit MVR, a ½ pixel unit MVR, a 1 pixel unit MVR, a 2 pixel unit MVR, and a 4 pixel unit MVR, MVRs corresponding to indices are as shown in Table 1. When an MVR index is received from a bitstream, the image decoding apparatus 2100 may adjust the motion vector of the candidate block according to Equation 1 by using the MVR index as k.

Also, in Equation 1, >> or << that is a bit shift operation refers to an operation of reducing or increasing a size of the prediction motion vector. Also, offset refers to a value added or subtracted to indicate an integer pixel when pMV downscaled according to a k value does not indicate an integer pixel. offset may be differently determined according to each of an x-coordinate value and a y-coordinate value of a basic MV.

According to an embodiment, when the downscaled pMV is changed to indicate an integer pixel, the image encoding apparatus 2800 and the image decoding apparatus 2100 may change the downscaled pMV according to the same criterion.

According to an embodiment, when an x-coordinate value and a y-coordinate value of the downscaled pMV do not indicate an integer pixel, the image encoding apparatus 2800 and the image decoding apparatus 2100 may always increase or decrease the x-coordinate value and the y-coordinate value of the downscaled pMV to indicate an integer pixel. Alternatively, the image encoding apparatus 2800 and the image decoding apparatus 2100 may round the x-coordinate value and the y-coordinate value of the downscaled pMV to indicate an integer pixel.

According to an embodiment, when the prediction motion vector is adjusted, the image encoding apparatus 2800 and the image decoding apparatus 2100 may omit downscaling and upscaling of the prediction motion vector, and may adjust the prediction motion vector in a coordinate plane in a reference image interpolated according to the minimum MVR to indicate a pixel unit corresponding to the MVR of the current block.

Also, according to an embodiment, when the prediction motion vector is adjusted in consideration of the MVR of the current block and the minimum MVR, the image encoding apparatus 2800 and the image decoding apparatus 2100 may adjust the prediction motion vector according to Equation 2, instead of Equation 1.

pMV′=((pMV+offset)>>k)≥≥k [Equation 2]

Although Equation 2 is similar to Equation 1, unlike in Equation 1 where offset is applied to the downscaled pMV, offset is applied to original pMV and then is downscaled according to k.

The image encoding apparatus 2800 may find a motion vector of the current block by using the MVR of the current block, and may obtain a difference between the motion vector of the current block and the selectively adjusted prediction motion vector as a differential motion vector. The image decoding apparatus 2100 may obtain a sum of the differential motion vector of the current block and the selectively adjusted prediction motion vector, as the motion vector of the current block. According to an embodiment, when the MVR of the current block is less than a 1 pixel unit MVR, the image decoding apparatus 2100 may interpolate the reference image according to the minimum MVR and then may search for a prediction block according to the motion vector of the current block. Also, when the MVR of the current block is equal to or higher than a 1 pixel unit MVR, the image decoding apparatus 2100 may search for the prediction block according to the motion vector of the current block without interpolating the reference image.

Adjustment of the prediction motion vector has been described above as being performed according to a result of the comparison between the MVR of the current block and the minimum MVR. However, as described above, when the first MVR of the first component of the motion vector of the current block and the second MVR of the second component of the motion vector of the current block are independently determined, the first component value and the second component value of the prediction motion vector may also be independently adjusted. In detail, when the first MVR is greater than the minimum MVR, the image encoding apparatus 2800 and the image decoding apparatus 2100 may adjust the first component value of the prediction motion vector; and, when the second MVR is greater than the minimum MVR, the image encoding apparatus 2800 and the image decoding apparatus 2100 may adjust the second component value of the prediction motion vector.

For example, it is assumed that the minimum MVR is a ¼ pixel unit, the first MVR of the current block is a 1 pixel unit, and the first component value of the prediction motion vector indicates a coordinate (19) based on the coordinates (0,0). In order to adjust the first component value of the prediction motion vector to a 1 pixel unit MVR that is the MVR of the current block, the coordinate (19) of a pixel indicated by the first component value may be divided by 4, and coordinates (19/4) corresponding to a result of the division may not indicate an integer pixel unit.

The image encoding apparatus 2800 and the image decoding apparatus 2100 may adjust a downscaled first component vector to indicate an integer pixel unit. For example, respective coordinates of neighboring integer pixels located in a first component direction based on the coordinates (19/4) become (16/4) and (20/4). In this case, the image encoding apparatus 2800 and the image decoding apparatus 2100 may adjust the downscaled first component value to indicate the coordinates (20/4) located at the right instead of the coordinates (19/4), and then may multiply an integer 4 (that is, upscale) again so that a finally adjusted first component value indicates a pixel corresponding to a coordinate (20). According to an embodiment, the image encoding apparatus 2800 and the image decoding apparatus 2100 may adjust the downscaled first component value to the coordinates (16/4) located at the left instead of the coordinates (19/4).

For example, it is assumed that the minimum MVR is a ¼ pixel unit, the second MVR of the current block is a 1 pixel unit, and the second component value of the prediction motion vector indicates a coordinate (27) based on the coordinates (0,0). In order to adjust the second component value of the prediction motion vector to a 1 pixel unit MVR that is the MVR of the current block, the coordinate (27) of a pixel indicated by the second component value may be divided by 4, and coordinates (27/4) corresponding to a result of the division may not indicate an integer pixel unit.

The image encoding apparatus 2800 and the image decoding apparatus 2100 may adjust a downscaled second component vector to indicate an integer pixel unit. For example, respective coordinates of neighboring integer pixels located in a second component direction based on the coordinates (27/4) become (24/4) and (28/4). In this case, the image encoding apparatus 2800 and the image decoding apparatus 2100 may adjust the downscaled second component value to indicate the coordinates (28/4) located at the top instead of the coordinates (27/4), and then may multiply an integer 4 (that is, upscale) again so that a finally adjusted second component value indicates a pixel corresponding to a coordinate (28). According to an embodiment, the image encoding apparatus 2800 and the image decoding apparatus 2100 may adjust the downscaled second component value to the coordinates (24/4) located at the bottom instead of the coordinates (27/4).

According to an embodiment, the image encoding apparatus 2800 and the image decoding apparatus 2100 may adjust the first component value and the second component value of the prediction motion vector, based on Equation 1 or 2.

Meanwhile, the embodiments of the disclosure described above may be written as computer-executable programs that may be stored in a medium.

The medium may continuously store the computer-executable programs, or temporarily store the computer-executable programs or instructions for execution or downloading. Also, the medium may be any one of various recording media or storage media in which a single piece or plurality of pieces of hardware are combined, and the medium is not limited to a medium directly connected to a computer system, but may be distributed on a network. Examples of the medium include magnetic media, such as a hard disk, a floppy disk, and a magnetic tape, optical recording media, such as CD-ROM and DVD, magneto-optical media such as a floptical disk, and ROM, RAM, and a flash memory, which are configured to store program instructions. Other examples of the medium include recording media and storage media managed by application stores distributing applications or by websites, servers, and the like supplying or distributing other various types of software.

While one or more embodiments of the disclosure have been described with reference to the figures, it will be understood by those of ordinary skill in the art that various changes in form and details may be made therein without departing from the spirit and scope as defined by the following claims.

1. A method of decoding motion information, the method comprising:
determining a coding factor value of a differential motion vector of a current block, when adaptive encoding has been applied to the differential motion vector;
determining a first result value generated by applying the adaptive encoding to the differential motion vector, based on information included in a bitstream;
obtaining the differential motion vector by applying the determined coding factor value to the first result value according to a certain operation; and
obtaining a motion vector of the current block, based on the obtained differential motion vector and a prediction motion vector of the current block.

2. The method of claim 1, wherein the determining of the first result value comprises determining a second result value generated by applying the adaptive encoding to the differential motion vector, based on information included in the bitstream, and
the obtaining of the differential motion vector comprises obtaining the differential motion vector by further applying the second result value to the certain operation.

3. The method of claim 1, wherein the determining of the coding factor value of the differential motion vector comprises:
obtaining factor value indicating information from the bitstream; and
determining the coding factor value, based on the obtained factor value indicating information.

4. The method of claim 1, wherein the determining of the coding factor value of the differential motion vector comprises determining the coding factor value of the differential motion vector, based on information related to at least one of the current block, a pre-decoded block, a current slice including the current block, a pre-decoded slice, a current picture including the current block, and a pre-decoded picture.

5. The method of claim 1, further comprising, when the adaptive encoding is not applied to the differential motion vector of the current block, determining the differential motion vector of the current block, based on information obtained from the bitstream.

6. The method of claim 1, further comprising:
determining a first motion vector resolution of a first component of the motion vector of the current block and a second motion vector resolution of a second component of the motion vector of the current block;
adjusting a first component value and a second component value of the prediction motion vector, based on results of comparisons between a predetermined minimum motion vector resolution and each of the first motion vector resolution and the second motion vector resolution; and
obtaining the motion vector of the current block, based on the adjusted prediction motion vector and the differential motion vector.

7. The method of claim 6, wherein the determining of the coding factor value of the differential motion vector comprises determining the coding factor value, based on the first motion vector resolution and the second motion vector resolution.

8. The method of claim 6, wherein the adjusting of the first component value and the second component value of the prediction motion vector comprises adjusting the first component value of the prediction motion vector when the first motion vector resolution is greater than the minimum motion vector resolution, and adjusting the second component value of the prediction motion vector when the second motion vector resolution is greater than the minimum motion vector resolution.

9. The method of claim 6, wherein the determining of the first motion vector resolution and the second motion vector resolution comprises determining the first motion vector resolution and the second motion vector resolution, based on information representing the first motion vector resolution, which is obtained from the bitstream, and information representing the second motion vector resolution, which is obtained from the bitstream.

10. The method of claim 6, wherein the determining of the first motion vector resolution and the second motion vector resolution comprises determining the first motion vector resolution and the second motion vector resolution, based on a width and a height of the current block.

11. The method of claim 10, wherein the determining of the first motion vector resolution and the second motion vector resolution comprises determining the first motion vector resolution and the second motion vector resolution so that the first motion vector resolution is greater than the second motion vector resolution, when the width is larger than the height.

12. An image decoding apparatus comprising:
an obtainer configured to obtain a bitstream; and
a prediction decoder configured to determine a coding factor value of a differential motion vector of a current block, when adaptive encoding has been applied to the differential motion vector, determine a first result value generated by applying the adaptive encoding to the differential motion vector, based on information included in the bitstream, obtain the differential motion vector by applying the determined coding factor value to the first result value according to a certain operation, and obtain a motion vector of the current block, based on the obtained differential motion vector and a prediction motion vector of the current block.

13. A method of encoding motion information, the method comprising:
obtaining a differential motion vector of a current block, based on a motion vector of the current block and a prediction motion vector of the current block;
determining a coding factor value of the differential motion vector, when adaptive encoding is applied to the differential motion vector;
obtaining a first result value of the differential motion vector by applying the determined coding factor value to the differential motion vector according to a certain operation; and
generating a bitstream, based on the first result value of the differential motion vector.

14. The method of claim 13, further comprising obtaining a second result value of the differential motion vector by applying the determined coding factor value to the differential motion vector according to the certain operation, and
the generating of the bitstream comprises generating the bitstream, based on the first result value and the second result value of the differential motion vector.

15. The method of claim 14, wherein the determining of the coding factor value of the differential motion vector comprises, when each of a plurality of factor value candidates is applied to the differential motion vector, determining a factor value candidate causing a smallest overall number of bits of a first result value and a second result value of the differential motion vector and factor value indication information representing a factor value candidate, to be the coding factor value of the differential motion vector of the current block.
